(19) United States
(12) Patent Application Publication
(10) Pub. No.: US 2011/0221824 A1
(43) Pub. Date: Sep. 15, 2011

(54) LIQUID JETTING HEAD, METHOD OF CHARGING LIQUID FOR LIQUID JETTING HEAD, LIQUID JETTING RECORDING DEVICE, AND METHOD OF USING SAME

(76) Inventors: Akifumi Sakata, Chiba (JP); Tominaga Kazuyoshi, Chiba (JP); Watanabe Toshiaki, Chiba (JP); Kayama Ayako, Chiba (JP)

(21) Appl. No.: 12/998,282

(22) PCT Filed: Aug. 19, 2009
(86) PCT No.: PCT/JP2009/064483

§ 371 Date: May 20, 2011

(30) Foreign Application Priority Data
Oct. 9, 2008 (JP) 2008-262784

(51) Int. Cl. B41J 2/04; B41J 2/175

(52) U.S. Cl. 347/54; 347/85

(57) ABSTRACT

To improve a space factor of a liquid jet head to improve flexibility in designing a liquid jet recording apparatus, and to improve the ability to collect excess liquid to prevent contamination with excess liquid and stabilize jetting of liquid after the liquid is filled, provided is a liquid jet head including a nozzle guard (24) formed so as to cover a nozzle plate (31), the nozzle guard (24) including a top plate portion (24a), the top plate portion being disposed away from a surface of the nozzle plate (31) and having a slit (24c) formed therein so as to be opposed to a nozzle column (31c), and an airtight portion (24) for hermetically sealing space between a peripheral portion of the top plate portion (24a) and the nozzle plate (31), and in which an absorber (60) for absorbing excess ink (Y) which overflows from nozzle holes (31a) is disposed between the top plate portion (24a) of the nozzle guard (24) and the nozzle plate (31).

### TECHNICAL FIELD

The present invention relates to a liquid jet head and a liquid jet recording apparatus for jetting liquid from nozzles to record an image or text on a recording medium.

### BACKGROUND ART

Generally, a liquid jet recording apparatus, for example, an ink jet printer which carries out various kinds of printing, includes a transfer apparatus for transferring a recording medium and an ink jet head. As an ink jet head used here, there is known an ink jet head including a nozzle body (jetting body) having a nozzle column (jetting hole column) formed of a plurality of nozzle holes (jetting holes), a plurality of pressure generating chambers which are paired with and communicate with the nozzle holes, respectively, an ink supply system for supplying ink to the pressure generating chambers, and a piezoelectric actuator disposed adjacent to the pressure generating chambers, in which the piezoelectric actuator is driven to pressurize the pressure generating chambers to cause ink in the pressure generating chambers to be jetted from nozzles in the nozzle holes.

As a kind of such an ink jet printer, there is known an ink jet printer in which a carriage for moving the ink jet head in a direction orthogonal to the direction of transfer of recording paper (recording medium) is provided and printing is carried out on the recording paper. In an inkjet printer of such a kind, a service station for maintenance is provided in a movable range of the ink jet head, and the ink jet head is moved to the service station at which the nozzle holes are cleaned and the ink jet head is capped and sucked under negative pressure to initially fill the nozzle holes with ink. Patent Document 1 discloses a structure in which an ink absorber for absorbing ink includes a cap which is provided in a fitting state and ink in ink orifices of a recording head is sucked by a suction pump connected to the cap under a state in which the recording head and the cap are in abutment with each other.

An ink jet printer of a kind which is different from the kind of the above-mentioned ink jet printer is used for a relatively large-sized recording medium such as a box and carries out printing on a recording medium which is transferred with an ink jet head being fixed. In an ink jet printer of this kind, the ink jet head cannot be moved, and there is not enough space for providing a service station between the ink jet head and the recording medium or below the ink jet head. Therefore, it is difficult to provide a service station with a cap as in the structure in Patent Document 1. For example, when a service station is provided and ink is sucked from a recording head, it is necessary to cause the recording head to be in abutting contact with the cap and to hermetically seal ink orifices of the recording head with the cap. However, there is a problem in that, because it is difficult to secure the airtightness between the ink orifices and the cap, the ability to collect ink is low. Therefore, in initial filling of ink into the pressure generating chambers, ink is normally pressurized from the ink supply system side and filled.

In this pressurized filling, in order to prevent contamination of the ink jet head and of places in proximity to the ink jet printer with excess ink which droops from the nozzle holes, and in order to prevent unstable jetting of ink after the filling of the ink, it is necessary to take measures of removing excess ink. This is not limited to initial filling, and the same can be said with regard to a case in which ink which droops on a nozzle body in normal use is collected.

Patent Document 2 discloses an ink jet head in which an ink guide member formed of a plate-like porous absorber and protruding outwardly from a nozzle formation surface and a block-shaped ink absorber connected to the ink guide member are provided in a lower portion of the ink jet head, excess ink is received by the ink guide member and guided to the ink absorber, and the guided excess ink is absorbed in the ink absorber.

Patent Document 1: JP 06-218938 A

### Patent Document 2: JP 05-116338 A

### SUMMARY OF THE INVENTION

### Problem to be Solved by the Invention

However, in the structure disclosed in Patent Document 2, there is a problem in that, because the ink guide member and the ink absorber are provided below the ink jet head, space below the ink jet head may not be effectively used. Another problem is in that, therefore, printing cannot be carried out on a lower portion of a recording medium.

The present invention has been made in view of the above, and objects of the present invention are as follows:

(1) to improve a space factor of a liquid jet head to improve flexibility in designing a liquid jet recording apparatus; and
(2) to improve ability to collect excess liquid to prevent contamination with excess liquid and to stabilize jetting of liquid after the liquid is filled.

### Means for Solving the Problems

In order to achieve the objects described above, the present invention adopts the following means.

As solving means related to a liquid jet head, there is adopted means in which a liquid jet head including a jetting body having a jetting hole column formed of a plurality of jetting holes, a plurality of pressure generating chambers which are paired with and communicate with the plurality of jetting holes, respectively, a liquid supply system for supplying a first liquid to the plurality of pressure generating chambers, and an actuator disposed adjacent to the plurality of pressure generating chambers, the actuator being driven to pressurize the plurality of pressure generating chambers, thereby causing the first liquid in the plurality of pressure generating chambers to be jetted from liquid nozzles of the plurality of jetting holes, the liquid jet head includes: a jetting body guard formed so as to cover the jetting body, the jetting body guard including a top plate portion, the top plate portion being disposed away from a surface of the jetting body and having a slit formed therein so as to be opposed to the jetting hole column, and an airtight portion for hermetically sealing space between a peripheral portion of the top plate portion and the jetting body; and an absorber for absorbing excess liquid which flows out from the jetting body, the absorber being disposed between the top plate portion of the jetting body guard and the jetting body.

According to the structure, because excess liquid which flows out of the jetting body in initial filling of the liquid and in normal use is absorbed in the absorber, excess liquid can be collected before flowing out to the outside from the slit. Further, by disposing the absorber between the jetting body guard and the jetting body, excess liquid which overflows from the jetting holes can be collected by the absorber disposed inside the jetting body guard without providing a service station including a cleaning apparatus such as a wiper as in a conventional case. Therefore, space used for collecting excess liquid can be extremely small to improve the space factor of the liquid jet head and to improve the flexibility in designing the liquid jet head.

Further, because it is not necessary to attach a cap to the jetting body every time excess liquid is sucked, it is not necessary to secure the airtightness between the jetting body and the cap. More specifically, because excess liquid can be collected by the absorber which is disposed in advance inside the jetting body guard, the ability to collect excess liquid can be improved with a simple structure and contamination of the vicinity of the liquid jet head with excess liquid can be prevented. In this way, by achieving initial filling of the liquid jet head, jetting of the liquid after the liquid is filled can be stabilized.

Further, there is adopted means in which the liquid jet head further includes a suction flow path which has, on one end side thereof, a suction port which is open below the jetting hole column of the jetting body while another end side thereof being connected to a sucking portion to communicate with inside space of the jetting body guard in a case where the jetting hole column is disposed in a vertical direction, in which the inside space of the jetting body guard is caused to be a negative pressure chamber by suction with the sucking portion via the suction flow path, thereby collecting the first liquid which overflows from the plurality of jetting holes into the negative pressure chamber.

According to the structure, excess liquid in initial filling of liquid and in normal use flows out to the negative pressure chamber which communicates with the outside only via the slit, and gas outside the negative pressure chamber flows in the negative pressure chamber via the slit. This causes excess liquid to move through the negative pressure chamber under a state in which the excess liquid is less liable to leak to the outside via the slit, and to be sucked from the suction port into the suction flow path to be discharged to the outside. Further, because liquid can be continuously discharged through the suction flow path, the ability to collect excess liquid is extremely strong and, even if a large amount of excess liquid flows out to the negative pressure chamber, contamination with the excess liquid can be prevented and jetting of the liquid after the liquid is filled can be stabilized.

Further, by causing the inside space of the jetting body guard to be a negative pressure chamber, excess liquid which is absorbed in the absorber that is disposed inside the jetting bodyguard can be sucked together with excess liquid which flows out into the negative pressure chamber. Excess liquid sucked from within the absorber is sucked from the suction port into the suction flow path to be discharged to the outside. This can suppress saturation of absorption by the absorber, and thus, the ability of the absorber to perform collection can be kept to accommodate a large amount of excess liquid and the liquid jet head can be used for a long period of time. Further, because excess liquid absorbed in the absorber can be prevented from being dried and hardened, age deterioration of the absorber can be prevented and the maintenance becomes easier.

Further, as solving means related to the liquid jet head, there is adopted means in which the absorber is disposed in a direction of arrangement of the plurality of jetting holes on both sides of the slit in a width direction seen from a direction of opening of the slit.

According to the structure, by disposing the absorber on both sides of the slit in the width direction, excess liquid which flows out of the jetting body is reliably absorbed in the absorber before reaching the slit. This can prevent excess liquid from leaking to the outside via the slit.

Further, as solving means related to the liquid jet head, there is adopted means in which the absorber is disposed so as to surround a lower portion of the slit seen from the direction of opening of the slit.

According to the structure, by disposing the absorber so as to surround the lower portion of the slit, excess liquid which overflows from the jetting hole and flows downward can be efficiently absorbed.

Further, as solving means related to the liquid jet head, there is adopted means in which the absorber is disposed so as to surround a whole periphery of the slit seen from the direction of opening of the slit.

According to the structure, by disposing the absorber so as to surround the whole periphery of the slit, even if excess liquid attempts to leak from all directions toward the slit, excess liquid can be reliably absorbed before leaking to the outside via the slit.

Further, as solving means related to the liquid jet head, there is adopted means in which the absorber is disposed on a whole surface on a plane of the top plate portion seen from the direction of opening of the slit.

According to the structure, by disposing the absorber on the whole surface on the plane of the top plate portion, excess liquid which droops on a wall surface of the jetting body guard and on a wall surface of the jetting body can be reliably absorbed.

Further, as solving means related to the liquid jet head, there is adopted means in which the absorber is disposed so as to extend beyond an inner side of the slit seen from the direction of opening of the slit.

According to the structure, because the absorber is disposed so as to be seen through the slit, excess liquid which adheres to the periphery of the slit can be reliably absorbed, and excess liquid can be prevented from leaking via the slit.

Further, as solving means related to the liquid jet head, there is adopted means in which the absorber is disposed so as to cover at least a part of the suction port seen from the direction of opening of the slit.

According to the structure, because, by disposing the absorber so as to cover at least a part of the suction port, the absorber can be caused to be adjacent to the suction port, excess liquid absorbed in the absorber can be efficiently sucked. Further, excess liquid can be prevented from flowing back from the suction port.

Further, as solving means related to the liquid jet head, there is adopted means in which the absorber is disposed on the top plate portion side between the top plate portion and the jetting body.

According to the structure, by disposing the absorber on the top plate portion side, excess liquid which overflows from the jetting holes is reliably absorbed in the absorber before reaching the slit formed in the top plate portion. This can prevent excess liquid from leaking to the outside via the slit.

Further, as solving means related to the liquid jet head, there is adopted means in which the absorber is disposed on the jetting body side between the top plate portion and the jetting body.

According to the structure, by disposing the absorber on the jetting body side, excess liquid which overflows from the jetting hole can be more promptly absorbed in the absorber. This can prevent excess liquid from leaking to the outside via the slit.

Further, as solving means related to the liquid jet head, there is adopted means in which the absorber is disposed so as to fill space between the top plate portion and the jetting body.

According to the structure, by disposing the absorber so as to fill the space between the top plate portion and the jetting body, the amount of absorption in the absorber can be increased, and thus, excess liquid which overflows from the jetting holes is reliably absorbed in the absorber before reaching the slit formed in the top plate portion. This can prevent excess liquid from leaking to the outside via the slit.

Further, as solving means related to the liquid jet head, there is adopted means in which the absorber is provided so as to isolate the inside space of the slit and the suction port from each other.

According to the structure, air which flows in the inside space via the slit passes through the absorber and then is guided to the suction port side. Here, excess liquid absorbed in the absorber is guided into the suction port together with the air which passes through the absorber. This enables continuous suction of excess liquid absorbed in the absorber, which can promptly dry the absorber to suppress saturation of absorption by the absorber.

Further, as solving means related to the liquid jet head, there is adopted means in which a suction path is provided which communicates with the suction port and which extends in a direction of extension of the absorber.

According to the structure, because excess liquid sucked in the negative pressure chamber can be smoothly guided to the suction port, the ability to collect excess liquid can be improved.

Further, as solving means related to the liquid jet head, there is adopted means in which the slit is formed so that a direction of a long side thereof is in a direction of gravity and so that a lower end portion thereof is formed so as to be circular.

According to the present invention, even if excess liquid attempts to leak to the outside via the slit, a surface of liquid kept by surface tension at a lower end portion of the slit is hard to break and excess liquid tends to remain in the negative pressure chamber, and thus, contamination due to leakage of the excess liquid can be prevented and the ability to collect excess liquid can be improved.

Further, as solving means related to the liquid jet head, there is adopted means in which a recessed portion which is recessed toward the negative pressure chamber side is formed in the top plate portion of the jetting body guard, and the slit is formed in a bottom surface of the recessed portion.

According to the present invention, because the slit is formed in the bottom surface of the recessed portion, even if the jetting body guard is brought into contact with a recording medium or the like, the probability of contact of a water-repellent film in proximity to the slit with the recording medium or the like is reduced, and the water-repellent film can be prevented from peeling off.

Further, as solving means related to the liquid jet head, there is adopted means in which a ring-shaped protruding wall which protrudes to the negative pressure chamber side and which surrounds the slit in a shape of a ring is formed on the top plate portion of the jetting body guard.

According to the present invention, because the ring-shaped protruding wall blocks excess liquid from running on an inner surface toward the slit, excess liquid can be prevented from leaking via the slit. In particular, when liquid is jetted toward a recording medium with the nozzles of the liquid jet head being oriented downward, even if excess liquid remains in the inside space after the pressure in the negative pressure chamber recovers, excess liquid can be effectively prevented from leaking via the slit.

Further, as solving means related to a liquid jet recording apparatus, there is adopted means in which a liquid j et recording apparatus includes: any one of the liquid jet head adopting the above-mentioned solving means; and a liquid supply portion formed to be capable of supplying the first liquid to the liquid supply system.

According to the structure, because any one of the droplet jet heads adopting the above-mentioned solving means is included, the space factor of the liquid jet recording apparatus can be improved and the flexibility in designing the liquid jet recording apparatus can be improved.

Further, as solving means related to the liquid jet recording apparatus, there is adopted means in which the liquid supply portion is formed to be capable of switchedly supplying the first liquid and a second liquid to the liquid supply system.

According to the structure, because two kinds of liquid are supplied to the liquid supply system, for example, ink and a cleaning liquid may be supplied to the liquid supply system to reduce the labor of cleaning the liquid jet head and to carry out the cleaning efficiently. This enables the ability to collect excess liquid to be restored.

Further, cleaning liquid supplied from the liquid supply system is absorbed in the absorber in the inside space of the nozzle guard during the cleaning liquid is discharged from the suction port to the outside. Therefore, the absorber can be cleaned simultaneously with cleaning of the liquid jet head, and ink can be prevented from remaining in the absorber. This can prevent ink remaining in the absorber from being dried, hardened, and the like, and the maintenance of the absorber becomes easier.

Further, as solving means related to the liquid jet recording apparatus, there is adopted means in which any one of the liquid jet recording apparatus adopting the above-mentioned solving means further includes a reuse liquid supply system for collecting by sucking the first liquid which overflows in the negative pressure chamber and for supplying the first liquid to the plurality of pressure generating chambers.

According to the present invention, the first liquid which overflows in the negative pressure chamber may be reused.

Further, as solving means related to the liquid jet recording apparatus, there is adopted means in which, in any one of the liquid. jet recording apparatus adopting the above-mentioned solving means, the reuse liquid supply system includes a filter portion or a deaerator.

According to the present invention, liquid in an appropriate state may be reused.

Further, as solving means related to a method of filling liquid into a liquid jet head, there is adopted means in which a method of filling liquid into the liquid jet head, the liquid jet head including a nozzle body having a nozzle column formed of a plurality of nozzle holes, a plurality of pressure generating chambers which are paired with and communicate with the plurality of nozzle holes, respectively, a liquid supply system for supplying a first liquid to the plurality of pressure generating chambers, and an actuator disposed adjacent to the plurality of pressure generating chambers, the actuator being driven to pressurize the plurality of pressure generating chambers, thereby causing the first liquid in the plurality of pressure generating chambers to be jetted from nozzles of the plurality of nozzle holes, the liquid jet head further including: a nozzle guard formed so as to cover the nozzle column, the nozzle guard including a top plate portion, the top plate portion being disposed away from a surface of the nozzle body and having a slit formed therein so as to be opposed to the nozzle column, and an airtight portion for hermetically sealing space between a peripheral portion of the top plate portion and the nozzle body; and a suction flow path which has a suction port that is open below the nozzle column and which communicates with inside space of the nozzle guard, the inside space of the nozzle guard being caused to be a negative pressure chamber by a sucking portion connected to the suction flow path, the first liquid which overflows from the plurality of nozzle holes into the negative pressure chamber being sucked, the method includes pressurized filling the first liquid into the plurality of pressure generating chambers, the pressurized filling being carried out using the liquid supply system, under a state in which pressure in the negative pressure chamber is caused to be lower than atmospheric pressure by the sucking portion.

According to the present invention, compared with a case in which pressurized filling of liquid into the pressure generating chambers is carried out under a state in which the pressure in the inside space is equal to atmospheric pressure, because an inflow of air via the slit continuously occurs, excess liquid is less liable to leak via the slit. Further, because the suction port continuously discharges excess liquid, excess liquid does not accumulate in the inside space (negative pressure chamber) to overflow from the slit. This enables filling of liquid while contamination with excess liquid is prevented, and jetting of the, liquid after the liquid is filled can be stabilized.

Further, as solving means related to the method of filling liquid into a liquid jet head, there is adopted means in which the pressurized filling ends under a state in which the pressure in the negative pressure chamber is caused to be lower than the atmospheric pressure by the sucking portion.

According to the present invention, because pressurized filling ends under a state in which the negative pressure chamber is a negative pressure chamber and liquid does not flow out to the negative pressure chamber, compared with a case in which pressurized filling into the pressure generating chambers ends after the pressure in the inside space recovers, excess liquid is less liable to leak via the slit and does not overflow from the slit. This enables filling of liquid while contamination with excess liquid is prevented, and jetting of the liquid after the liquid is filled can be stabilized.

Further, a method of using a liquid jet recording apparatus according to the present invention, the method using the above-mentioned liquid jet recording apparatus according to the present invention, the method includes performing a liquid filling mode in which, by operating the sucking portion by first output, the inside space is caused to become a negative pressure chamber and the liquid that leaks from the jetting hole column is sucked via the suction flow path.

According to the structure, by operating the sucking portion by first output, the inside space of the jetting body guard is caused to become a negative pressure chamber in which the pressure is negative enough compared with atmospheric pressure. In this case, in initial filling of the liquid and in normal use, excess liquid which is supplied from a liquid supply portion and leaks from the jetting hole column flows out to the negative pressure chamber which communicates with the outside only via the slit, and gas outside the negative pressure chamber flows in the negative pressure chamber via the slit. This causes excess liquid to move through the negative pressure chamber under a state in which the excess liquid is less liable to leak to the outside via the slit, and to be sucked from the suction port into the suction flow path to be discharged to the outside, and thus, liquid which flows out of the jetting hole column can be collected.

Therefore, excess liquid is prevented from leaking via the slit and initial filling of the liquid can be carried out.

Further, a method of using the above-mentioned liquid jet recording apparatus according to the present invention, the method includes performing switching control carried out between a liquid filling mode in which, by operating the sucking portion by first output, the inside space is caused to become a negative pressure chamber and the liquid that leaks from the jetting hole column is sucked via the suction flow path and a normal use mode in which the sucking portion is operated by second output which is smaller than the first output and the liquid is jetted from the jetting hole column toward a recording medium to carry out recording on the recording medium.

According to the structure, in the normal use mode, by operating the sucking portion by second output which is smaller than the output in the liquid filling mode, even if excess liquid which leaks from the jetting holes in printing or the like or excess liquid which remains in the inside space of the jetting body guard after the liquid is filled exists, excess liquid can be prevented from leaking via the slit by sucking the excess liquid. Therefore, from initial filling of liquid up to printing can be carried out without providing a service station with the direction of openings of the jetting holes being the direction of gravity.

### Effects of the Invention

According to the present invention, because excess liquid which flows out of the jetting body in initial filling of the liquid and in normal use is absorbed in the absorber, excess liquid can be collected before flowing out of the slit to the outside. Further, by disposing the absorber between the jetting body guard and the jetting body, excess liquid which overflows from the jetting holes can be collected by the absorber disposed inside the jetting body guard without providing a service station including a cleaning apparatus such as a wiper as in a conventional case. Therefore, space used for collecting excess liquid can be extremely small to improve the space factor of the liquid jet head and to improve the flexibility in designing the liquid jet head.

Further, because it is not necessary to attach a cap to the jetting body every time excess liquid is sucked, it is not necessary to secure the airtightness between the jetting body and the cap. More specifically, because excess liquid can be collected by the absorber which is disposed in advance inside the jetting body guard, the ability to collect excess liquid can be improved with a simple structure and contamination of the vicinity of the liquid jet head with excess liquid can be prevented. In this way, by achieving initial filling of the liquid jet head, jetting of the liquid after the liquid is filled can be stabilized.

### BRIEF DESCRIPTION OF THE DRAWINGS

FIG. 1 is a perspective view illustrating an ink jet recording apparatus 1 according to an embodiment of the present invention.

FIG. 2 is a schematic structural view of the ink jet recording apparatus 1 seen from a right side according to the embodiment of the present invention, in which a part of the structure is in section.

FIG. 3 is a front view of an ink jet head 10 according to a first embodiment of the present invention.

FIG. 4 is a schematic structural view of the ink jet recording apparatus 1 seen from a right side according to the first embodiment of the present invention, in which a part of the structure is in section.

FIG. 5 is a sectional view taken along the line I-I of FIG. 4 in the first embodiment of the present invention.

FIG. 6 is an exploded perspective view of a head chip 20 according to the embodiment of the present invention.

FIG. 7 is an exploded perspective view illustrating details of a ceramic piezoelectric plate 21 and an ink chamber plate 22 according to the embodiment of the present invention.

FIG. 8 shows graphs of a relationship among operation timing of a suction pump 16, operation timing of a pressure pump 54, and space S (negative pressure chamber R) according to the embodiment of the present invention.

FIG. 9 are enlarged sectional views of a principal part of the head chip 20 illustrating operation of initial filling according to the embodiment of the present invention.

FIG. 10 are plan views of ink jet heads illustrating modified examples of the ink jet head according to the first embodiment of the present invention.

FIG. 11 illustrate an ink jet head 200 according to a second embodiment of the present invention. FIG. 11(a) is a plan view and FIG. 11(b) is a sectional view taken along the line A-A of FIG. 11(a).

FIG. 12 is a plan view of an ink jet head illustrating a modified example of the ink jet head according to the second embodiment of the present invention.

FIG. 13 illustrate an ink jet head 300 according to a third embodiment of the present invention. FIG. 13(a) is a plan view and FIG. 13(b) is a sectional view taken along the line B-B of FIG. 13(a).

FIG. 14 are enlarged views of principal parts of ink jet heads 80, 90, and 100 illustrating modified examples of the ink jet head 10 according to the first embodiment of the present invention.

### BEST MODES FOR CARRYING OUT THE INVENTION

Embodiments of the present invention are described in the following with reference to the attached drawings.

### First Embodiment

(Liquid Jet Recording Apparatus)

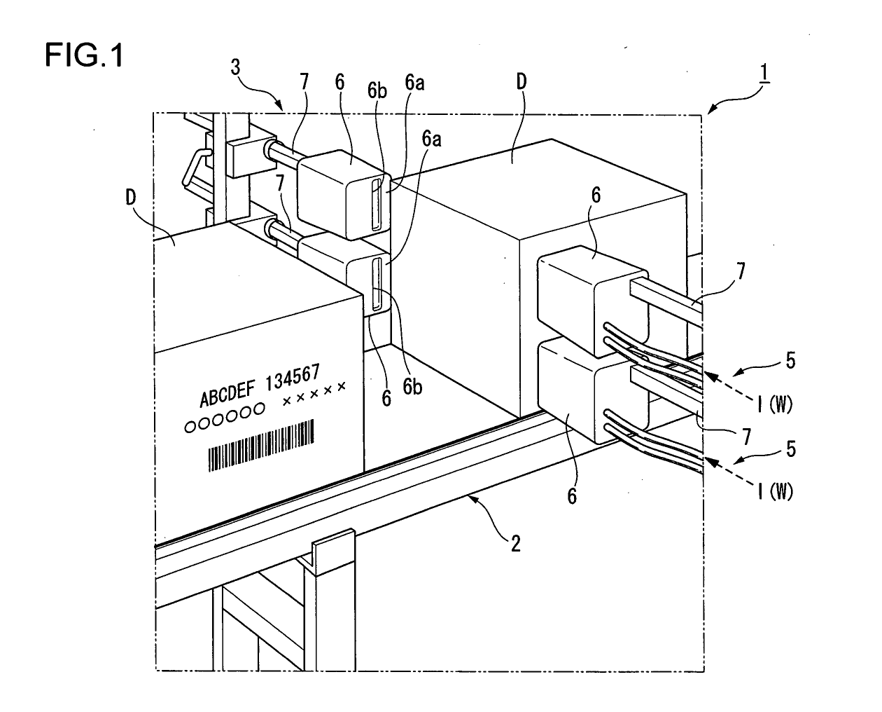

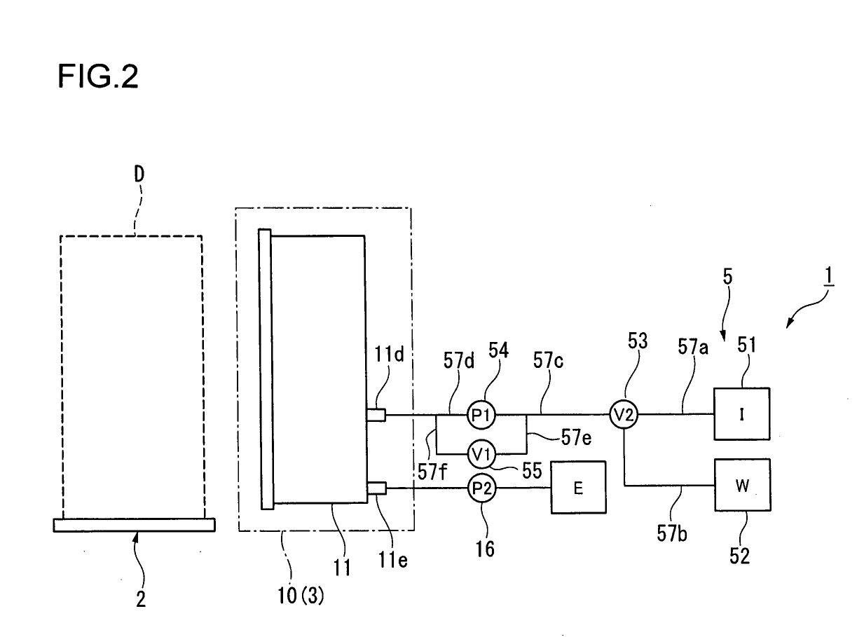

FIG. 1 is a perspective view illustrating an ink jet recording apparatus (liquid jet recording apparatus) 1 according to a first embodiment of the present invention. FIG. 2 is a schematic structural view of the inkjet recording apparatus 1. The inkjet recording apparatus 1 is connected to a predetermined personal computer, and carries out printing on a box D by, based on print data sent from the personal computer, discharging (jetting) ink (liquid) 1. The ink jet recording apparatus 1 includes a belt conveyor 2 for transferring the box D in one direction, an ink discharging portion 3 including a plurality of ink jet heads (liquid jet heads) 10, an ink supply portion 5 for, as illustrated in FIG. 2, supplying the ink (liquid) 1 and a cleaning liquid (second liquid) W to the ink jet head 10, and a suction pump (sucking portion) 16 connected to the ink jet head 10.

The ink discharging portion 3 discharges the ink I to the box D, and, as illustrated in FIG. 1, includes four enclosures 6 in the shape of rectangular parallelepipeds. The ink jet heads 10 are placed in the enclosures 6, respectively (see FIG. 2). The enclosures 6 are disposed in pairs on both sides of the belt conveyor 2 in a width direction with ink discharge surfaces 6a thereof being oriented to the belt conveyor 2 side, respectively. Two of the enclosures 6 disposed on both sides of the belt conveyor 2 in the width direction are vertically aligned with the other two of the enclosures 6 and all the enclosures 6 are supported by support members 7, respectively. It is to be noted that an opening 6b is formed in the ink discharge surface 6a of the enclosure 6.

(Liquid Jet Head)

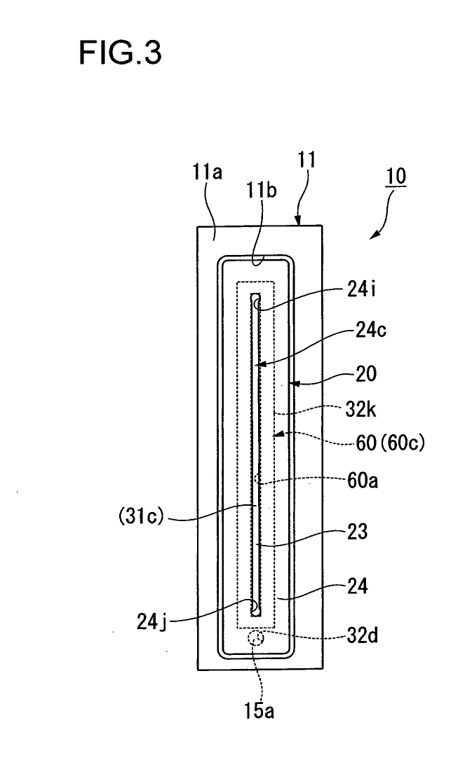

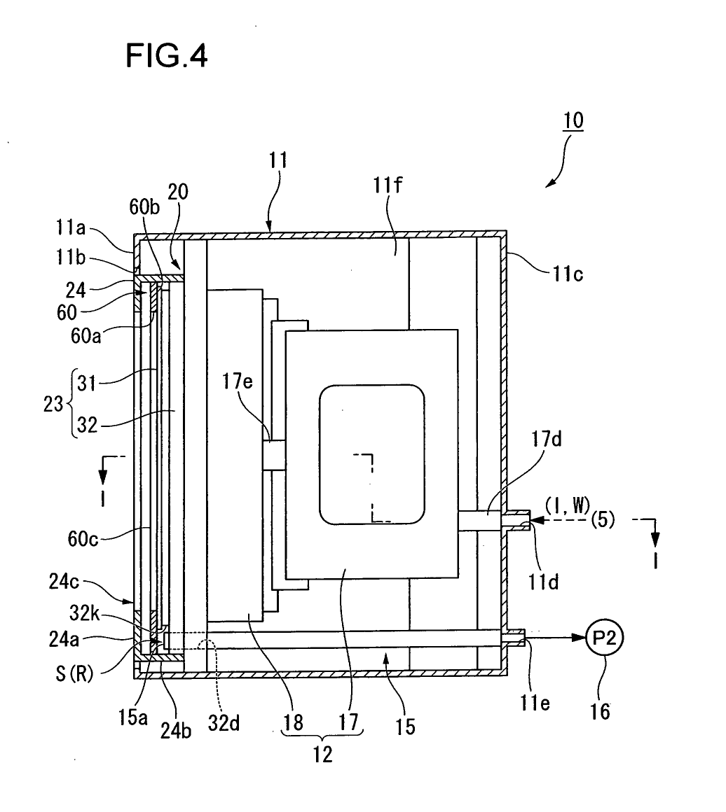

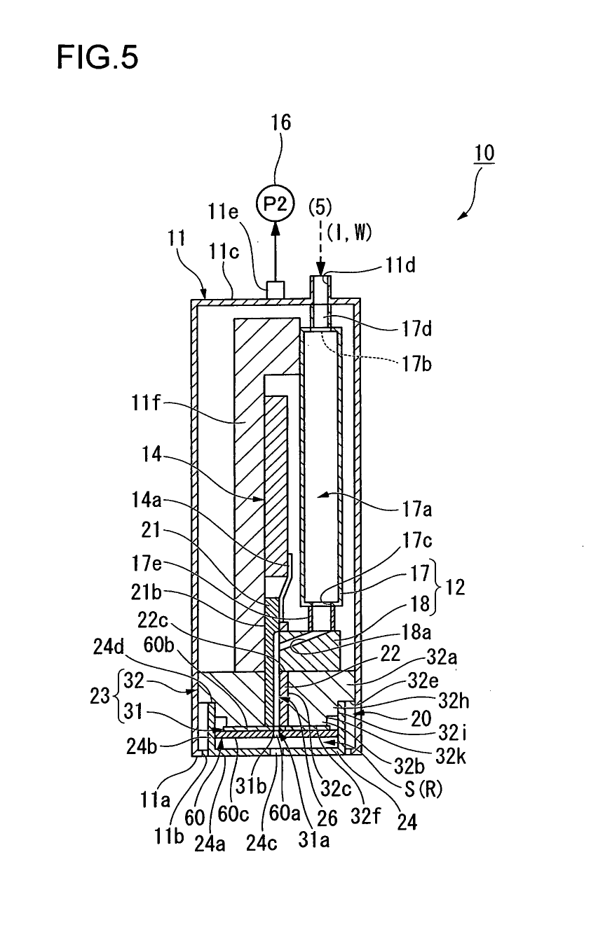

FIG. 3 is a front view of the ink jet head 10. FIG. 4 is a schematic structural view of the ink jet head 10 viewed from a right side. FIG. 5 is a sectional view taken along the line I-I of FIG. 4.

As illustrated in FIG. 4, the ink jet head 10 includes a case 11, a liquid supply system 12, a head chip 20, a drive circuit board 14 (see FIG. 5), and a suction flow path 15.

The case 11 is in the shape of a thin box with an exposure hole 11b formed in a front surface 11a thereof, and is fixed in the enclosure 6 with a thickness direction thereof being horizontal and with the exposure hole 11b oriented to the opening 6b. As illustrated in FIG. 4 and FIG. 5, through holes for communicating with internal space are formed in a back surface 11c of the case 11. More specifically, an ink injection hole 11d is formed in a substantially middle portion in a height direction, and an ink suction hole 11e is formed in a lower portion. The case 11 includes in the internal space thereof a base plate 11f fixed to the case 11 so as to be upright, and houses structural items of the ink jet head 10.

The liquid supply system 12 communicates with the ink supply portion 5 via the ink injection hole 11d, and substantially formed of a damper 17 and an ink flow path substrate 18.

As illustrated in FIG. 5, the damper 17 is for the purpose of adjusting pressure fluctuations of the ink I, and includes a storing chamber 17a for storing the ink I. The damper 17 is fixed to the base plate 11f and includes an ink intake hole 17b connected to the ink injection hole 11d via a tube member 17d and an ink outflow hole 17c connected to the ink flow path substrate 18 via a tube member 17e.

The ink flow path substrate 18 is, as illustrated in FIG. 4, a member formed so as to be vertically long, and, as illustrated in FIG. 5, a member having a circulation path 18a formed therein, which communicates with the damper 17 and through which the ink I passes, and is attached to the head chip 20.

As illustrated in FIG. 5, the drive circuit board 14 includes a control circuit (not shown) and a flexible substrate 14a. The drive circuit board 14 applies voltage to a ceramic piezoelectric plate (actuator) 21 according to a print pattern with one end of the flexible substrate 14a being joined to plate-like electrodes 28 to be described later and the other end being joined to a control circuit (not shown) on the drive circuit board 14. The drive circuit board 14 is fixed to the base plate 11f.

(Head Chip)

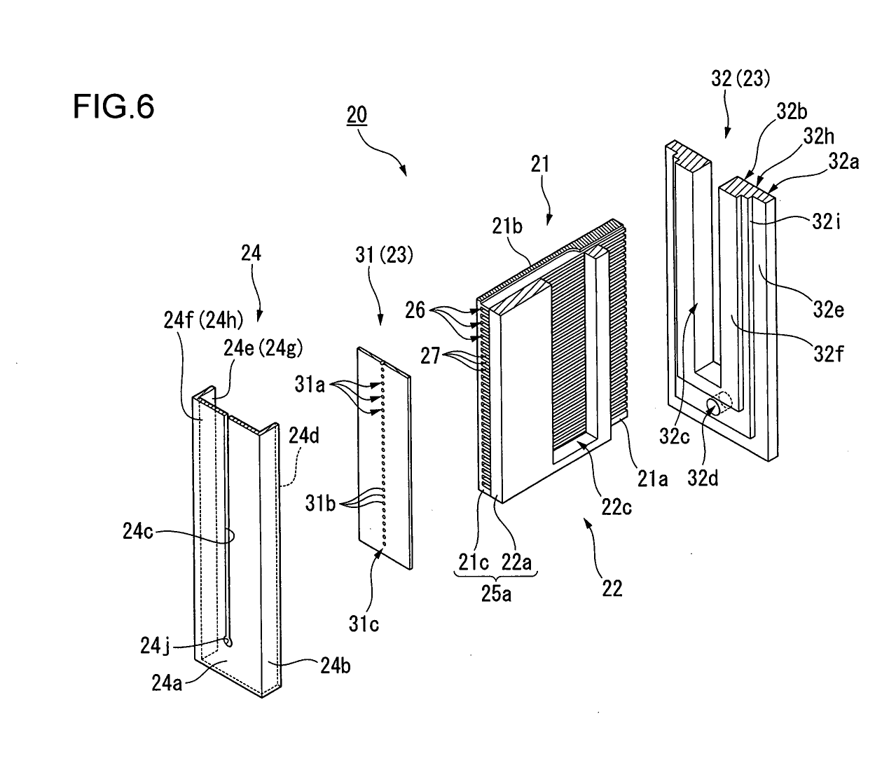

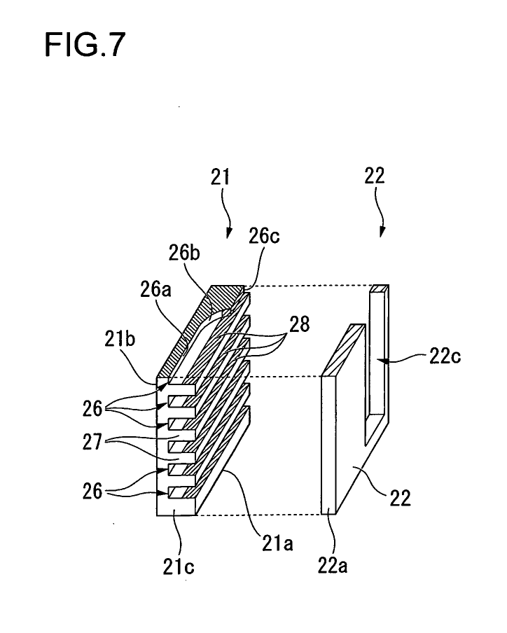

FIG. 6 is an exploded perspective view of the head chip 20. FIG. 7 is an exploded perspective view illustrating details of the ceramic piezoelectric plate 21 and an ink chamber plate 22. It is to be noted that, in FIG. 6, an absorber 60 to be described later is omitted.

As illustrated in FIG. 6, the head chip 20 includes the ceramic piezoelectric plate 21, the ink chamber plate 22, a nozzle body (jetting body) 23, and a nozzle guard (jetting body guard) 24.

The ceramic piezoelectric plate 21 is a substantially rectangular plate-like member formed of lead zirconate titanate (PZT) and, as illustrated in FIG. 6 and FIG. 7, has a plurality of long grooves (pressure generating chambers) 26 provided on one plate surface 21a of two plate surfaces 21a and 21b thereof so as to be stacked on top of one another, and the respective long grooves 26 are isolated from one another by side walls 27.

As illustrated in FIG. 6, the long grooves 26 are provided so as to extend in a direction of a short side of the ceramic piezoelectric plate 21, and the plurality of long grooves 26 are provided so as to be stacked on top of one another over the whole length in a direction of a long side of the ceramic piezoelectric plate 21. As illustrated in FIG. 7, each of the long grooves 26 is formed so that its section in a thickness direction of the piezoelectric actuators is rectangular. A bottom surface of each of the long grooves 26 includes a front flat surface 26a which extends from a front side surface 21c of the ceramic piezoelectric plate 21 to a substantially middle portion in the direction of the short side, a sloped surface 26b at which the depth of the groove gradually becomes smaller from an end of the front flat surface 26a toward a back side surface, and a back flat surface 26c which extends from an end of the sloped surface 26b toward the back side surface. It is to be noted that the respective long grooves 26 are formed with a disc-like dice cutter.

The plurality of side walls 27 are provided so as to be stacked on top of one another over the long side of the ceramic piezoelectric plate 21 for partitioning into the long grooves 26. The plate-like electrodes 28 for applying drive voltage are provided on the opening side of the long grooves 26 of wall surfaces of the side walls 27 (on the plate surface 21a side) so as to extend in the direction of the short side of the ceramic piezoelectric plate 21. The plate-like electrodes 28 are formed by publicly known oblique deposition. The above-mentioned flexible substrate 14a is joined to the plate-like electrodes 28.

As illustrated in FIG. 5, a portion of the plate surface 21b on the back side surface side of the ceramic piezoelectric plate 21 is fixed to an edge portion of the base plate 11f, and the long grooves 26 extend toward the exposure hole 11b.

Reference is made again to FIG. 6 and FIG. 7. The ink chamber plate 22 is, similarly to the ceramic piezoelectric plate 21, a substantially rectangular plate-like member. Compared with the size of the ceramic piezoelectric plate 21, the ink chamber plate 22 is formed so that its size in the direction of the long side is substantially the same as that of the ceramic piezoelectric plate 21 and its size in the direction of the short side is smaller than that of the ceramic piezoelectric plate 21. The ink chamber plate 22 includes an open hole 22c which passes through the thickness and which is formed over the long side of the ink chamber plate 22.

It is to be noted that, although the ink chamber plate 22 may be formed of a ceramic plate, a metal plate, or the like, taking into consideration deformation after being joined to the ceramic piezoelectric plate 21, a ceramic plate the coefficient of thermal expansion of which is similar thereto is used.

As illustrated in FIG. 6, the ink chamber plate 22 is joined to the ceramic piezoelectric plate 21 from the plate surface 21a side so that a front side surface 22a thereof and the front side surface 21c of the ceramic piezoelectric plate 21 are flush with each other and form an abutting surface 25a. In this joined state, the open hole 22c exposes the whole of the plurality of long grooves 26 of the ceramic piezoelectric plate 21, all the long grooves 26 are open to the outside, and the respective long grooves 26 are in a communicating state.

As illustrated in FIG. 5, the ink flow path substrate 18 is attached to the ink chamber plate 22 so as to cover the open hole 22c. The circulation path 18a in the ink flow path substrate 18 communicates with the respective long grooves 26.

As illustrated in FIG. 5, the nozzle body 23 is formed by sticking a nozzle plate 31 to a nozzle cap 32.

As illustrated in FIG. 6, the nozzle plate 31 is a thin-plate-like, strip-like member formed of polyimide, and a plurality of nozzle holes 31a which pass through the thickness thereof line up to form a nozzle column 31c. More specifically, the nozzle holes 31a the number of which is the same as that of the long grooves 26 are formed in line at the middle in the direction of the short side of the nozzle plate 31 at the same intervals as those of the long grooves 26.

A water-repellent film which is water-repellent for the purpose of preventing adhesion of ink and the like is applied to, of two plate surfaces of the nozzle plate 31, a plate surface to which nozzle orifices (nozzles) 31b for discharging the ink I is open, while the other plate surface is a surface to which the abutting surface 25a and the nozzle cap 32 are joined.

It is to be noted that the nozzle holes 31a are formed using an excimer laser.

The nozzle cap 32 is a member in the shape of a frame-plate-like member with an outer periphery of one of two frame surfaces being cut away, and is a member including a thin-plate-like outer frame portion 32a, a middle frame portion 32h which is thicker than the outer frame portion 32a, an inner frame portion 32b which is thicker than the middle frame portion 32h, a long hole 32c which passes through the thickness at the middle portion in the direction of the short side of the inner frame portion 32b and which extends in the direction of the long side, and a discharge hole 32d which passes through the thickness at an end portion of the middle frame portion 32h. In other words, the middle frame portion 32h and the inner frame portion 32b protrude in the thickness direction from an outer frame surface 32e of the outer frame portion 32a so as to be step-like so that the contour of a section in the thickness direction is like stairs in which the heights of the outer frame portion 32a, the middle frame portion 32h, and the inner frame portion 32b become larger in this order toward the long hole 32c.

The nozzle plate 31 is stuck to an inner frame surface 32f which extends in the same direction as the outer frame surface 32e so as to block the long hole 32c. A ring-shaped end portion 24d of the nozzle guard 24 is in abutting contact with the outer frame surface 32e and with the middle frame portion 32h which extends from the outer frame surface 32e in a direction of the normal to the outer frame surface 32e.

The nozzle body 23 is housed in the internal space of the case 11 so that the discharge hole 32d of the nozzle cap 32 is located on a lower side (see FIG. 3), and is fixed to the case 11 and the base plate 11f (see FIG. 5).

In this state, a part of the ceramic piezoelectric plate 21 and a part of the ink chamber plate 22 are inserted in the long hole 32c and the nozzle plate 31 is in abutment with the abutting surface 25a. Further, the nozzle plate 31 is adhered to the inner frame surface 32f by an adhesive. Compared with the area of the inner frame surface 32f, the area of the nozzle plate 31 is formed so as to be larger, and the nozzle plate 31 is disposed so as to extend beyond the edges of the inner frame surface 32f to some extent.

In such a structure, when a predetermined amount of the ink I is supplied from the storing chamber 17a in the damper 17 to the ink flow path substrate 18, the supplied ink I is fed via the open hole 22c into the long grooves 26. It is to be noted that a gap between the ink chamber plate 22 and the long grooves 26 on the back flat surface 26c side of the long grooves 26 (see FIG. 7) is sealed by a sealing material.

(Nozzle Guard)

The nozzle guard 24 is a member substantially in the shape of a box formed of stainless steel or the like, and is formed by press forming. The nozzle guard 24 includes a top plate portion 24a formed so as to be rectangular-plate-like, and an airtight portion 24b which extends from a peripheral portions of the top plate portion 24a in a direction substantially orthogonal to a surface of the plate.

The top plate portion 24a has a plate surface the size of which is substantially the same as that of the inner frame surface 32f, and includes at the middle portion in the direction of a short side thereof a slit 24c which extends in the direction of a long side thereof. The slit 24c is formed so as to be a little longer than the nozzle column 31c, and both end portions (upper end portion 24i and lower end portion 24j) thereof are formed in the shape of a circle.

The width dimension of the slit 24c is set to be about 1.5 mm while the nozzle diameter of the nozzle holes 31a is 40 μm. The width dimension of the slit 24c is desirably set so that the upper limit thereof is the largest size at which the suction pump 16 can generate negative pressure and the lower limit thereof is the smallest size at which, in the initial filling of the ink I, the ink I does not overflow from the slit 24c to droop.

Further, the upper end portion 24i and the lower end portion 24j are formed in the shape of a circle the diameter of which is a little larger than the above-mentioned width dimension.

As illustrated in FIG. 6, a hydrophilic film 24g is formed by titanium coating on an inward inner surface 24e of the nozzle guard 24, while a water-repellent film 24h is formed by fluorine resin coating or Teflon (registered trademark) plating on an outer surface 24f on a back surface of the inner surface 24e and on an inner surface of the slit 24c.

The ring-shaped end portion 24d of the nozzle guard 24 is adhered to the outer frame surface 32e with an adhesive so that the top plate portion 24a covers the inner frame portion 32b and the discharge hole 32d (see FIG. 3) and so that the inner surface 24e of the airtight portion 24b and a middle side surface 32i of the middle frame portion 32h are in abutting contact with each other. In this way, the nozzle guard 24 is attached to the nozzle cap 32 so as to cover the nozzle cap 32 (see FIG. 5). Therefore, a groove (suction path) 32k in the thickness direction of the nozzle guard 24 is formed between the middle frame portion 32h and the inner frame portion 32b of the nozzle cap 32 and the inner surface 24e of the nozzle guard 24 so as to surround the whole periphery of the nozzle plate 31 (see FIG. 5). In this state, the nozzle guard 24 covers the nozzle column 31c via space (inside space) S so that the slit 24c is opposed to the nozzle column 31c and so that the slit 24c is not opposed to the discharge hole 32d. In other words, the nozzle guard 24 covers the nozzle orifices 31b so that the nozzle column 31c is seen through the slit 24c and the discharge hole 32d is not seen through the'slit 24c in the direction of opening of the slit 24c (see FIG. 3).

The distance between the top plate portion 24a of the nozzle guard 24 and the nozzle plate 31 is desirably set so that the upper limit thereof is the largest distance at which the suction pump 16 can generate negative pressure and the lower limit thereof is the smallest distance at which, in the initial filling of the ink I, the ink I does not overflow from the slit 24c.

As illustrated in FIG. 4, the suction flow path 15 is formed by fitting and inserting one end of a tube to be the suction port 15a in the discharge hole 32d to be fixed and connecting the other end to the ink suction hole 11e. As described above, the suction port 15a is opened to a location which is not opposed to the slit 24c.

The suction pump 16 is connected to the ink suction hole 11e via a tube. In operation, the suction pump 16 sucks air and the ink I in the space S to cause the space S to become a negative pressure chamber R. It is to be noted that the suction pump 16 stores the sucked ink I in a waste liquid tank E (see FIG. 2).

Reference is made again to FIG. 2. The ink supply portion 5 includes an ink tank 51 in which the ink I is stored, a cleaning liquid tank 52 in which the cleaning liquid W is stored, a changeover valve 53 which can switch between two flow paths, a pressure pump 54 which supplies the ink I or the cleaning liquid W to the ink jet head 10 in a pressurized state, and an open/close valve 55 which can open and close the flow paths.

The ink tank 51 and the cleaning liquid tank 52 communicate with the pressure pump 54 via a supply tube 57a, the changeover valve 53, and a supply tube 57c, and via a supply tube 57b, the changeover valve 53, and the supply tube 57c, respectively. More specifically, the supply tubes 57a and 57b as inflow tubes and the supply tube 57c as an outflow tube are connected to the changeover valve 53.

The pressure pump 54 is connected to the supply tube 57c and communicates with the ink jet head 10 via a supply tube 57d, and supplies the ink I or the cleaning liquid W, which flows in from the supply tube 57c, to the ink jet head 10. The pressure pump 54 is formed not to allow fluid to flow therethrough in a non-operating state, and has a function like an open/close valve.

The open/close valve 55 is connected to a supply tube 57e which communicates with the supply tube 57c to be an inflow tube and to a supply tube 57f which communicates with the supply tube 57d to be an outflow tube. More specifically, when the open/close valve 55 is opened, the supply tubes 57e and 57f function as a bypass of the pressure pump 54.

(Absorber)

Here, as illustrated in FIGS. 3 to 5, an absorber 60 for absorbing excess ink Y which overflows from the nozzle holes 31a is disposed inside the nozzle guard 24 (space S) and between the top plate portion 24a of the nozzle guard 24 and the nozzle plate 31. More specifically, the absorber 60 is a thin film in the shape of a rectangle seen in plan view the size of which is substantially the same as that of the top plate portion 24a along the plane of the nozzle guard 24, and a slit 60a the shape of which is substantially the same as that of the slit 24c in the nozzle guard 24 is formed at the middle portion in a width direction of the absorber 60 so as to avoid the nozzle column 31c. Therefore, the absorber 60 is disposed so as to cover the suction port 15a of the nozzle cap 32 seen in plan view (seen from the direction of opening of the slit 24c).

In the direction of space between the nozzle guard 24 and the nozzle plate 31 (horizontal direction in FIG. 4), the absorber 60 is disposed so as to be in abutting contact with an end surface of the nozzle plate 31. More specifically, the absorber 60 is disposed so as to surround the nozzle column 31c along the plane of the nozzle plate 31. Therefore, the above-mentioned groove 32k formed between the inner surface 24e of the nozzle guard 24 and the nozzle cap 32 is covered with the absorber 60, and a gap is formed between a rear surface 60b of the absorber 60 and the groove 32k. Further, with regard to the space S between the nozzle guard 24 and the nozzle plate 31, a front surface 60c side of the absorber 60 (nozzle guard 24 side) and the rear surface 60b side (nozzle plate 31 side) thereof are isolated from each other by the absorber 60.

It is to be noted that, as the material of the absorber 60, a porous film of such as polyvinyl alcohol (PVA) (for example, Belleater A series of Kanebo, Ltd.) or high-density polyethylene powder (for example, one manufactured by Asahi Kasei Corporation (Sunfine)) is preferably used. Further, the absorber 60 may be stuck on the end surface of the nozzle plate 31 using an adhesive. In this case, for example, it is preferred that the adhesion be made by applying spots of an adhesive of an epoxy resin or the like which has high viscosity.

Next, operation of the ink jet recording apparatus 1 structured as described above is described. In the following, a case in which printing is carried out on the box D after the ink jet head 10 is initially filled with the ink I is described, and further, a case in which the ink jet head 10 is cleaned is described.

(Initial Filling of Ink)

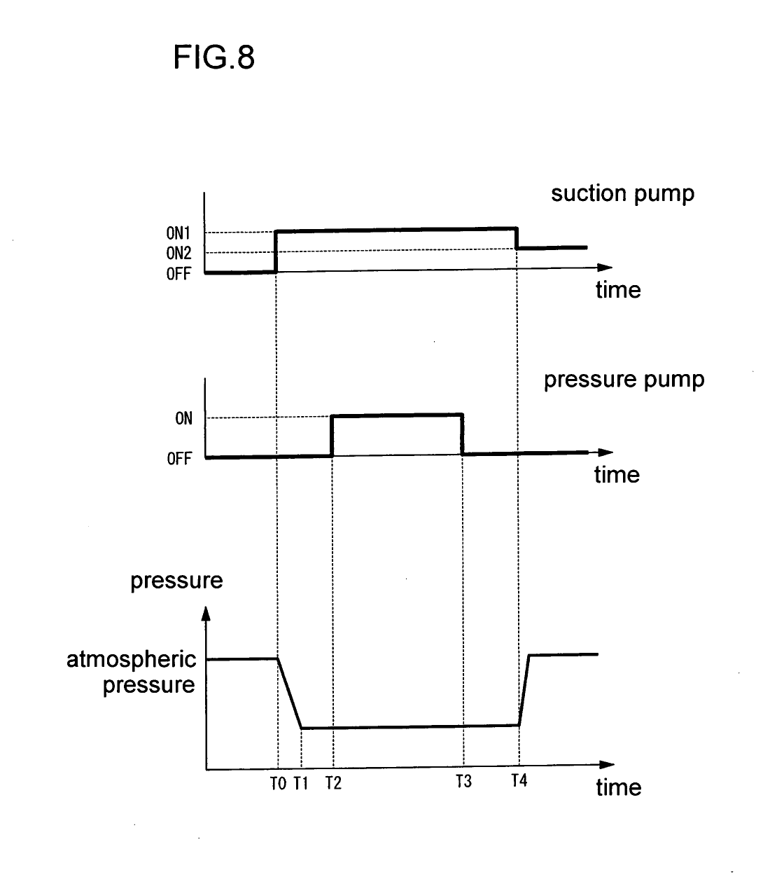

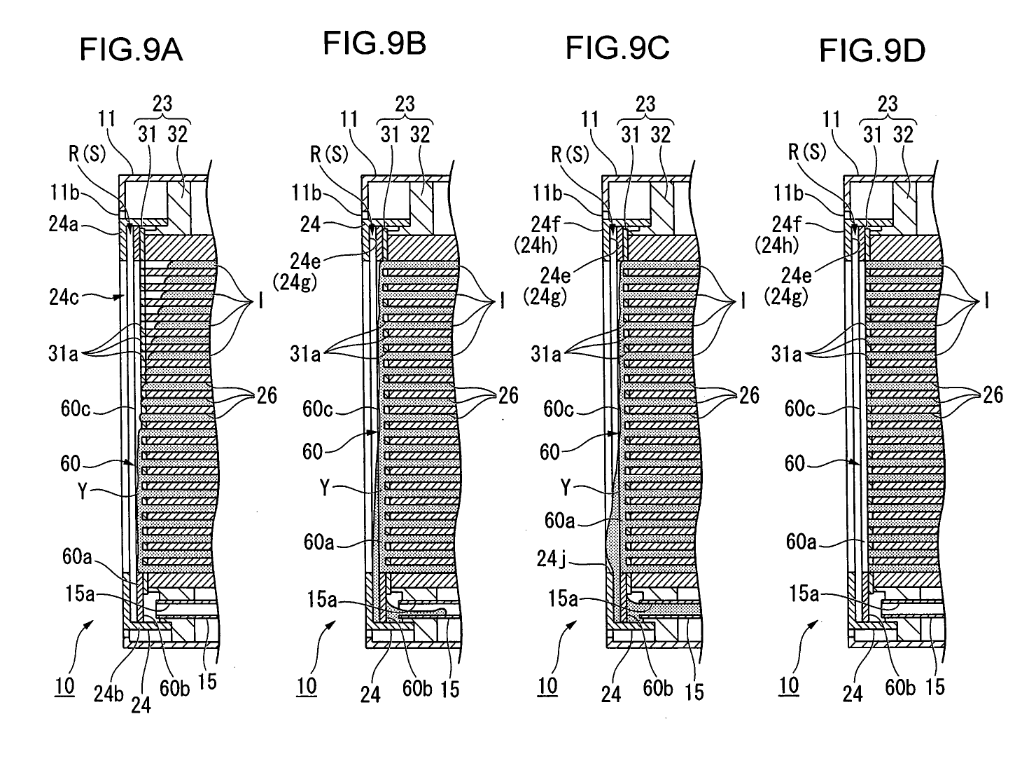

FIG. 8 shows graphs of a relationship among operation timing of the suction pump 16, operation timing of the pressure pump 54, and the space S (negative pressure chamber R). FIG. 9 are enlarged sectional views of a principal part of the head chip 20 illustrating operation of initial filling.

First, as illustrated in FIGS. 4 and 8, the suction pump 16 is activated (ON1) and the suction pump 16 sucks air in the space S from the suction port 15a via the suction flow path 15 (at time T0 of FIG. 8). Here, it is preferred that the output of the operating suction pump 16 be set so as to cause the pressure in the space S to be negative enough, and the output here is filling output of the suction pump 16. When the suction pump 16 is activated by the filling output (first output), outside air flows from the slit 24c in the space S. By sucking the air after the air passes through the space S and reaches the suction port 15a, the space S is depressurized (liquid filling mode). After a predetermined time passes, at T1, the space S becomes the negative pressure chamber R in which the pressure is negative enough compared with atmospheric pressure.

After the space S becomes the negative pressure chamber R, the ink supply portion 5 carries out pressurized filling of the ink I into the ink jet head 10 (at time T2 of FIG. 8). Here, the ink supply portion 5 is set as in the following. That is, as illustrated in FIG. 2, the changeover valve 53 communicates the supply tube 57a and the supply tube 57c with each other, and the open/close valve 55 is closed to interrupt the communication between the supply tube 57e and the supply tube 57f. With this state being kept, the pressure pump 54 is activated. The pressure pump 54 injects the ink I from the ink tank 51 via the supply tubes 57a, 57c, and 57d into the ink injection hole 11d of the ink jet head 10.

As illustrated in FIGS. 4 and 5, the ink I injected into the ink injection hole 11d flows in the storing chamber 17a via the ink intake hole 17b in the damper 17, and then, flows out to the circulation path 18a in the ink flow path substrate 18 via the ink outflow hole 17c. Then, the ink I which flows in the circulation path 18a flows in the respective long grooves 26 via the open hole 22c.

The ink I which flows in the respective long grooves 26 flows to the nozzle hole 31a side, and, after reaching the nozzle holes 31a, as illustrated in FIG. 9(a), flows out from the nozzle holes 31a as excess ink Y. When the excess ink Y begins to flow out, because the amount is small, the excess ink Y flows downward (downward in the direction of gravity) on the nozzle plate 31. Then, the excess ink Y is absorbed in the absorber 60 disposed on the end surface of the nozzle plate 31 and runs through the absorber 60 to flow downward.

The excess ink Y which runs through the absorber 60 to reach a lower portion of the negative pressure chamber R is sucked from the suction port 15a into the suction flow path 15. With this, the excess ink Y absorbed in the absorber 60 is sucked to be discharged to the waste liquid tank E (see FIG. 9(b)).

Here, with regard to the space S (negative pressure chamber R), the front surface 60c side of the absorber 60 (nozzle guard 24 side) and the rear surface 60b side (nozzle plate 31 side) thereof are isolated from each other by the absorber 60. In this case, air which flows in the space S via the slit 24c passes through the absorber 60 in a thickness direction thereof, and then is guided into the groove 32k on the rear surface 60b side of the absorber 60. Air guided into the groove 32k runs downward in the groove 32k, reaches the suction port 15a, and is then sucked. Therefore, the extent of the negative pressure in the space S on the rear surface 60b side of the absorber 60, that is, the space between the absorber 60 and the groove 32k is higher than that of the space S on the front surface 60c side of the absorber 60. Further, because the groove 32k is formed so as to surround the whole periphery of the nozzle plate 31, air passes uniformly in the thickness direction over the whole surface of the absorber 60, and the rear surface 60b side of the absorber 60 becomes uniform negative pressure space.

Here, the excess ink Y absorbed in the absorber 60 is pushed out to the rear surface 60b side of the absorber 60 by air which passes through the absorber 60 from the front surface 60c side to the rear surface 60b side, and is guided into the groove 32k together with the air. The excess ink Y guided into the groove 32k flows downward in the groove 32k to be discharged from the suction port 15a to the waste liquid tank E. This enables continuous suction of the excess ink Y absorbed in the absorber 60, which can promptly dry the absorber 60 to suppress saturation of absorption by the absorber 60.

By the way, in the event that the amount of the excess ink Y which flows out is large and absorption by the absorber 60 is saturated, as illustrated in FIG. 9(b), the excess ink Y flows down not only on the nozzle plate 31 but also on the inner surface 24e of the nozzle guard 24. Here, air continuously flows in the negative pressure chamber R via the slit 24c and thus, the excess ink Y is less liable to flow out of the slit 24c to the outside. Supposing the amount of the excess ink Y which flows on the inner surface 24e in proximity to the slit 24c becomes locally large and a part of the excess ink Y reaches the vicinity of the outer surface 24f against air which flows in via the slit 24c, the excess ink Y is repelled by the water-repellent film 24h formed on the outer surface 24f. The repelled ink I is guided by the hydrophilic film 24g formed on the inner surface 24e and returns to the negative pressure chamber R again.

Further, in the lower end portion 24j of the slit 24c, surface tension acts on the ink I at the contour of a circular lower end portion 24j (at the boundary between the outer surface 24f and the lower end portion 24j). In the lower end portion 24j, strong surface tension acts on the ink I and the balance of the surface tension is kept, and thus, the surface of the ink I is not broken and the ink I does not leak to the outside. Further, similarly to the case described above, the ink I is guided by the water-repellent film 24h formed on the outer surface 24f and the hydrophilic film 24g formed on the inner surface 24e to be returned to the negative pressure chamber R.

In this way, the excess ink Y which flows out of the nozzle holes 31a is continuously discharged to the waste liquid tank E.

As illustrated in FIG. 8, after a predetermined time passes, at T3, the pressure pump 54 is stopped to end the pressurized filling of the ink I. In association with the stop of the pressure pump 54, the excess ink Y no longer flows out of the nozzle holes 31a, and the excess ink Y which remains in the negative pressure chamber R and the excess ink Y which is absorbed in the absorber 60 are sucked, and the sucked excess ink Y is discharged to the waste liquid tank E via the suction port 15a.

Then, after a predetermined time passes, at T4, the suction pump 16 is stopped. After the filling of the ink I is completed, as illustrated in FIG. 9(d), the long grooves 26 are filled with the ink I. It is to be noted that the pressure in the space S recovers to be atmospheric pressure again (see FIG. 8).

(In Printing)

Next, operation when printing is carried out on the box D is described. First, setting of the ink supply portion 5 is described. That is, as illustrated in FIG. 2, the supply tube 57a and the supply tube 57c are caused to communicate with each other by the changeover valve 53, and the open/close valve 55 is opened to communicate the supply tube 57e and the supply tube 57f with each other. With this state being kept, the pressure pump 54 is inactivated so that the supply tube 57c and the supply tube 57d do not communicate with each other via the pressure pump 54. In this state, the ink I is injected via the supply tubes 57a, 57c, 57e, 57f, and 57d into the ink injection hole 11d of the ink jet head 10.

The belt conveyor 2 is driven with the ink supply portion 5 being set as described above (see FIG. 1), the box D is transferred in one direction, and, when the transferred box D passes in front of the enclosures 6, that is, passes in front of the nozzle plates 31 (nozzle holes 31a), the ink discharging portions 3 discharge ink droplets toward the box D.

More specifically, based on print data which is input from an outside personal computer, the drive circuit board 14 selectively applies voltage to predetermined plate-like electrodes 28 correspondingly to the print data. This reduces the capacities of the long grooves 26 corresponding to the plate-like electrodes 28, and the ink I filled into the long grooves 26 is discharged from the nozzle orifices 31b toward the box D.

When the ink I is discharged, the long grooves 26 are under negative pressure, and thus, the ink I is filled into the long grooves 26 via the above-mentioned supply tubes 57a, 57c, 57e, 57f, and 57d.

In this way, the ceramic piezoelectric plate 21 of the ink jet head 10 is driven according to the image data, and ink droplets are discharged from the nozzle holes 31a to land on the box D. In this way, by continually discharging ink droplets from the ink jet head 10 while the box D is moved, an image (text) is printed on desired locations of the box D.

Here, in the ink jet head 10 of this embodiment, the arrangement of the nozzle column 31c is in the direction of gravity and the openings of the nozzle holes 31a are in the horizontal direction, but the present invention is not limited thereto. A structure in which the openings of the nozzle holes 31a are in the direction of gravity and the nozzle column 31c extends in the horizontal direction is also possible.

In such a case, because the direction of openings of the orifices 31b of the nozzle holes 31a is the direction of gravity, there is a case in which the excess ink Y which leaks from the nozzle holes 31a when the ink I is filled is not completely sucked and remains in a border portion between the top plate portion 24a of the nozzle guard 24 and the peripheral wall portion 24b or the like. Further, there is a possibility that, after the ink I is filled, for example, in printing, the excess ink Y leaks from the nozzle holes 31a.

Therefore, as illustrated in FIG. 8, in this embodiment, even after the ink I is filled, the suction pump 16 is operated all the time (ON2 of FIG. 8). Here, the output of the suction pump 16 is set so as to be smaller than the output when the ink I is filled (filling output) and so that, in printing, the excess ink Y existing in the space S can be sufficiently sucked (normal use mode). This causes the space S to be space the extent of the negative pressure of which is lower than that when the ink I is filled. It is to be noted that, when the output of the suction pump 16 is too large, the trajectories of ink droplets discharged from the nozzle holes 31a in printing are affected, and there is a possibility that the printing precision is affected, which is not preferred. The output of the suction pump 16 here is referred to as normal output (second output).

By carrying out printing under a state in which the suction pump 16 is operated by the normal output, the excess ink Y which leaks from the nozzle holes 31a and the excess ink Y which remains on the inner surface 24e of the nozzle guard 24 flow toward each of the suction flow paths 15. The ink I which reaches the suction flow path 15 is sucked into the suction flow path 15 to be discharged to the waste liquid tank E.

It is to be noted that operation of ON2 described as the normal use mode in FIG. 8 is not necessarily required to be carried out together with operation of ON1 in FIG. 8 described as the liquid filling mode as described above, and may be appropriately carried out depending on the operation environment and the kind of the ink I.

(In Cleaning)

Next, operation when the ink jet head 10 is cleaned is described. First, setting of the ink supply portion 5 is described. As illustrated in FIG. 2, the supply tube 57b and the supply tube 57c are caused to communicate with each other by the changeover valve 53, and the open/close valve 55 is closed to interrupt communication between the supply tube 57e and the supply tube 57f. With this state being maintained, the pressure pump 54 is activated. The pressure pump 54 injects the cleaning liquid W from the cleaning liquid tank 52 via the supply tubes 57b, 57c, and 57d into the ink injection hole 11d of the ink jet head 10.

Similarly to the case of the above-mentioned initial filling, the cleaning liquid W is caused to flow out of the nozzle holes 31a via the long grooves 26 and the like. More specifically, the cleaning liquid W which flows out of the nozzle holes 31a runs on the inner surface 24e of the nozzle guard 24 and on the nozzle cap 32 to flow downward, and is absorbed in the absorber 60 disposed on the end surface of the nozzle plate 31. The cleaning liquid W absorbed in the absorber 60 is absorbed in the absorber 60, and then, runs through the absorber 60 to flow downward and is sucked from the suction port 15a. Here, the cleaning liquid W which runs through the absorber 60 flows downward of the absorber 60 together with the ink I which remains in the absorber 60. More specifically, the inside of the absorber 60 is also cleaned by the cleaning liquid W and thus, the ink I does not remain in the absorber 60.

It is to be noted that, when the ink jet recording apparatus 1 is not used for a long time, the ink I which is filled into the long grooves 26 is dried and hardened. In this case, similarly to the case of the cleaning, by filling the ink jet head 10 with the cleaning liquid W, the ink jet recording apparatus 1 may be stored for a long time.

As described above, in this embodiment, the absorber 60 for absorbing the excess ink Y is disposed between the top plate portion 24a of the nozzle guard 24 and the nozzle plate 31.

According to the structure, because the excess ink Y which overflows from the nozzle holes 31a in initial filling of the ink I and in normal use is absorbed in the absorber 60, the excess ink Y can be collected before flowing out to the outside from the slit 24c. Further, by disposing the absorber 60 between the nozzle guard 24 and the nozzle plate 31 as in this embodiment, the excess ink Y can be collected by the absorber 60 disposed inside the nozzle guard 24 without providing a service station including a cleaning apparatus such as a wiper as in a conventional case. Therefore, space used for collecting the excess ink Y which flows out of the nozzle holes 31a can be extremely small to improve the space factor of the ink jet head 10 and to improve the flexibility in designing the ink jet head 10.

Further, because it is not necessary to attach a cap to the nozzle body every time the excess ink Y is sucked as in a conventional case, it is not necessary to secure the airtightness between the nozzle body and the cap. More specifically, because the excess ink Y can be collected by the absorber 60 which is disposed in advance inside the nozzle guard 24, the ability to collect the excess ink Y can be improved with a simple structure and contamination of the vicinity of the ink jet head 10 with the excess ink Y can be prevented. In this way, by achieving initial filling of the ink jet head 10, jetting of the liquid after the ink is filled can be stabilized.

Here, in this embodiment, the absorber 60 the size of which is substantially the same as that of the top plate portion 24a of the nozzle guard 24 is disposed on the end surface of the nozzle plate 31.

According to the structure, the space S between the nozzle guard 24 and the nozzle plate 31 is partitioned by the absorber 60 into the front surface 60c side of the absorber 60 and the rear surface 60b side thereof. In this case, because air which flows in the space S via the slit 24c passes through the absorber 60 in the thickness direction thereof, the air is guided into the groove 32k on the rear surface 60b side of the absorber 60 together with the excess ink Y absorbed in the absorber 60. With this, the excess ink Y absorbed in the absorber 60 passes through the groove 32k and is guided to the suction port 15a, and thus, the excess ink Y absorbed in the absorber 60 can be continuously sucked, which can promptly dry the absorber 60 to suppress saturation of absorption by the absorber 60. Therefore, the ability of the absorber 60 to perform collection can be kept for a long period of time.

Further, by disposing the absorber 60 so as to cover the suction port 15a seen in plan view, the absorber 60 can be caused to be adjacent to the suction port 15a, and thus, the excess ink Y absorbed in the absorber 60 can be efficiently sucked. Further, the excess ink Y can be prevented from flowing back from the suction port 15a.

Further, because the groove 32k is formed between the middle frame portion 32h and the inner frame portion 32b of the nozzle cap 32 and the inner surface 24e of the nozzle guard 24 so as to surround the whole periphery of the nozzle plate 31, air passes uniformly in the thickness direction over the whole surface of the absorber 60. This causes the rear surface 60b side of the absorber 60 to be uniform negative pressure space, and the excess ink Y absorbed in the absorber 60 can be sucked from the whole surface of the absorber 60. Therefore, the ability to collect the excess ink Y absorbed in the absorber 60 can be improved.

Further, in this embodiment, the nozzle guard 24 formed so as to cover the nozzle column 31c is used to form the space S (negative pressure chamber R) and the excess ink Y is discharged from the suction port 15a.

According to the structure, the excess ink Y flows out to the space S (negative pressure chamber R) which communicates with the outside only via the slit 24c, and gas outside the negative pressure chamber R flows in the negative pressure chamber R via the slit 24c. This causes the excess ink Y to move through the negative pressure chamber R in a state in which the excess ink Y is less liable to leak to the outside via the slit 24c, and to be sucked from the suction port 15a into the suction flow path 15 to be discharged to the outside. Further, because a large amount of the excess ink Y can be continuously discharged through the suction flow path, the ability to collect the excess ink Y is improved, and contamination with the excess ink Y can be prevented and discharge of the ink I after the ink I is filled can be stabilized.

Further, by causing the inside space of the nozzle guard 24 to be the negative pressure chamber R, the excess ink Y which is absorbed in the absorber 60 that is disposed inside the nozzle guard 24 can be sucked together with the excess ink Y which flows out into the negative pressure chamber R. The excess ink Y sucked from within the absorber 60 is sucked from the suction port 15a into the suction flow path to be discharged to the outside. This can suppress saturation of absorption by the absorber 60, and thus, the ability of the absorber 60 to perform collection can be kept to accommodate a large amount of the excess ink Y and the ink jet head 10 can be used for a long period of time. Further, because the excess ink Y absorbed in the absorber 60 can be prevented from being dried and hardened, age deterioration of the absorber 60 can be prevented and the maintenance becomes easier.

Further, because the ink supply portion 5 is formed to be able to switchedly supply the ink I and the cleaning liquid W and the ink I and the cleaning liquid W are supplied to the liquid supply system 12, the labor of cleaning the ink jet head 10 can be reduced and the ink jet head 10 can be cleaned efficiently.

Further, the cleaning liquid W supplied from the liquid supply system 12 is absorbed in the absorber 60 in the space S during the cleaning liquid W is discharged from the suction port 15a to the outside. Therefore, the absorber 60 can be cleaned simultaneously with cleaning of the ink jet head 10, and the ink I can be prevented from remaining in the absorber 60. This can prevent the ink I remaining in the absorber 60 from being dried, hardened, and the like, and the maintenance of the absorber 60 becomes easier.

In this structure, the space S becomes the negative pressure chamber R in which the pressure is negative enough compared with atmospheric pressure, and pressurized filling of the ink I starts in a state in which the ink I that flows out to the negative pressure chamber R is less liable to flow toward the slit 24c. Therefore, compared with a case in which pressurized filling of the ink I into the long grooves 26 is carried out with the pressure in the space S being equal to atmospheric pressure including a case in which the nozzle guard 24 and the space S are not formed, an inflow of air via the slit 24c continuously occurs, and thus, the excess ink Y is less liable to leak via the slit 24c. Further, because the suction port 15a continuously discharges the excess ink Y, the excess ink Y does not accumulate in the space S (negative pressure chamber R) to overflow from the slit 24c.

Further, because pressurized filling ends with the space S being the negative pressure chamber R and liquid does not flow out to the negative pressure chamber R, compared with a case in which pressurized filling into the long grooves 26 ends after the pressure in the space S recovers, the excess ink Y is less liable to leak via the slit 24c and does not overflow from the slit 24c. This enables filling of the ink I while contamination with the excess ink Y is prevented, and discharge of the ink I after the ink I is filled can be stabilized.

(Modified Examples)

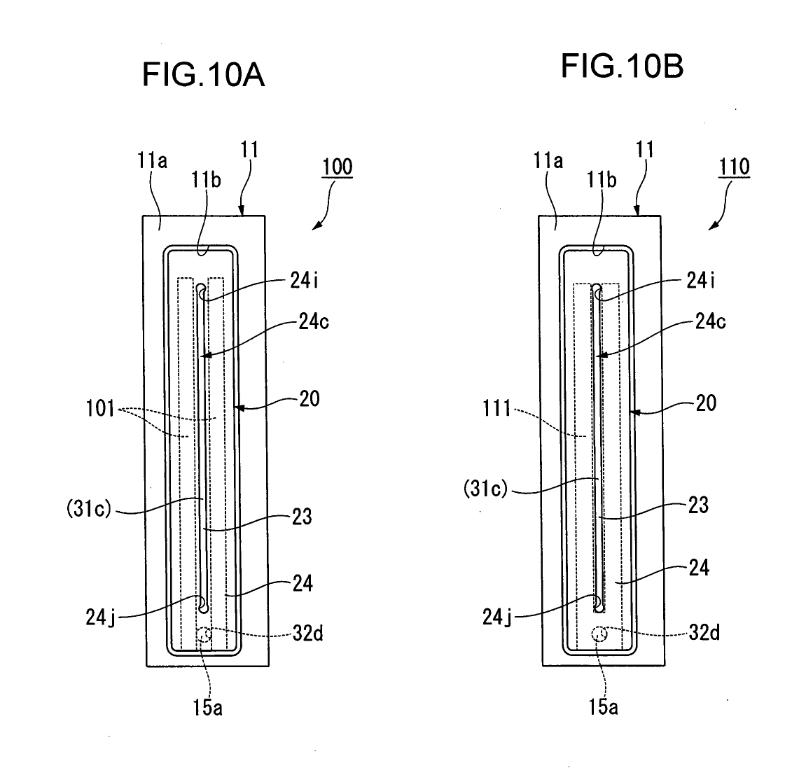

Next, specific modified examples of the ink jet head 10 are described. It is to be noted that like numerals and symbols are used to designate like or identical members in the ink jet head 10, and description thereof is omitted. FIG. 10 are plan views of ink jet heads illustrating modified examples of the present invention. Further, in the following description, the above-mentioned FIGS. 1 to 9 are referred to as appropriate.

As illustrated in FIG. 10 (a), in an ink jet head 100 of this modified example, two absorbers 101 which extend in the direction of arrangement of the nozzle holes 31a are disposed on both sides in the width direction of the slit 24c in the nozzle guard 24. More specifically, each of the absorbers 101 extends in the direction of arrangement of the nozzle column 31c on the end surface of the nozzle plate 31 and reaches the airtight portion 24b in a lower portion of the nozzle guard 24. In other words, the absorbers 101 are disposed so as to sandwich the nozzle column 31c and the discharge hole 32d from both sides thereof. It is to be noted that the absorbers 101 are formed of a material similar to that of the absorber 60 (see FIG. 4) of the first embodiment described above.

According to the structure, because the absorbers 101 are disposed on both sides of the nozzle column 31c in the direction of arrangement of the nozzle holes 31a, the excess ink Y which overflows from the nozzle holes 31a (see FIG. 9) can be promptly absorbed. Further, because the absorbers 101 are disposed so as to sandwich the suction port 15a from both sides thereof, the excess ink Y which is absorbed in the absorbers 101 and runs through the absorbers 101 can be guided to the vicinity of the suction port 15a. Therefore, the excess ink Y absorbed in the absorbers 101 can be smoothly sucked to be discharged to the waste liquid tank E.

As illustrated in FIG. 10(b), in an ink jet head 110 of this modified example, an absorber 111 which is U-shaped seen in plan view is disposed on the end surface of the nozzle plate 31. More specifically, the absorber 111 is formed of a material similar to that of the absorber 60 (see FIG. 4) of the first embodiment described above, and covers the whole region of the suction port 15a seen in plan view and extends on both sides of the nozzle column 31c in the direction of arrangement of the nozzle holes 31a.

According to the structure, because the absorber 111 is disposed so as to cover the suction port 15a, the pressure in the vicinity of the absorber 111 easily becomes negative and the excess ink Y absorbed in the absorber 111 can be efficiently sucked.

### Second Embodiment

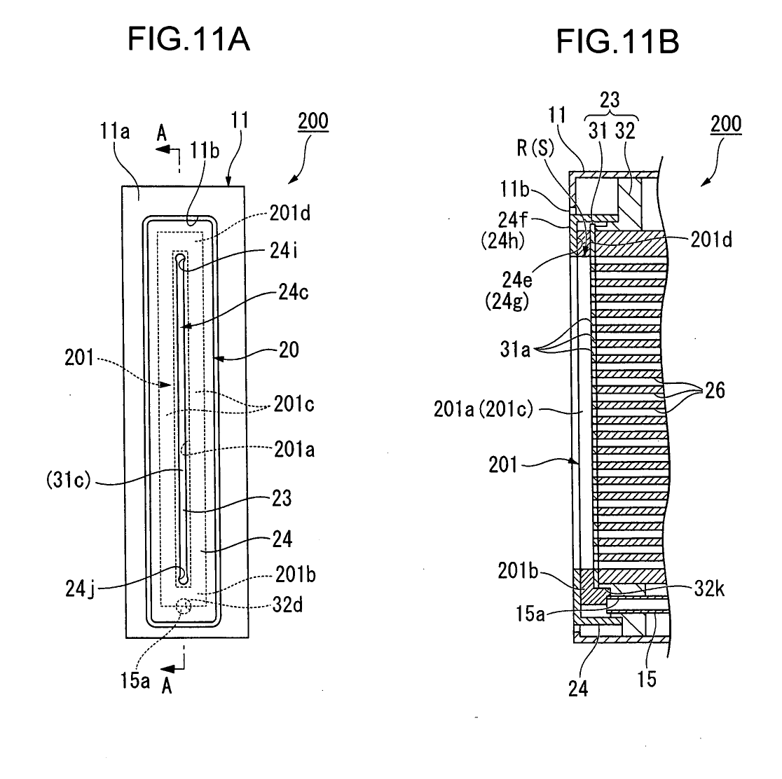

Next, a second embodiment of the present invention is described. It is to be noted that like numerals and symbols are used to designate like or identical members in the first embodiment described above, and description thereof is omitted. FIG. 11 illustrate an ink jet head in the second embodiment of the present invention. FIG. 11(a) is a plan view and FIG. 11(b) is a sectional view taken along the line A-A of FIG. 11(a). This embodiment is different from the first embodiment described above in that the absorber is disposed in the whole region in the direction of the space between the nozzle guard and the nozzle plate.

As illustrated in FIG. 11, in an ink jet head 200 of this embodiment, an absorber 201 is disposed so as to surround the whole periphery of the slit 24c on the plane of the top plate portion 24a of the nozzle guard 24. More specifically, the absorber 201 includes a lower end portion 201b which covers an upper half portion of the suction port 15a seen in plan view, side portions 201c which are on both sides of the nozzle column 31c and which extend in the direction of arrangement of the nozzle column 31c from both ends of the lower end portion 201b in the width direction, and an upper end portion 201d formed so as to run between one ends of the side portions 201c, respectively. In other words, the absorber 201 is formed so as to be O-shaped seen in plan view and so as to have a slit 201a the shape of which is substantially the same as that of the slit 24c. It is to be noted that the absorber 201 is formed of a material similar to that of the absorber 60 (see FIG. 4) of the first embodiment described above.

The absorber 201 is disposed so as to fill the whole region in the direction of the space between the nozzle guard 24 and the nozzle plate 31 (horizontal direction in FIG. 11(b)). In other words, the thickness of the space S is equal to the thickness of the absorber 201.

In this case, in the space S, an inner peripheral side and an outer peripheral side on the plane of the top plate portion 24a are isolated from each other with the absorber 201 therebetween. A lower half portion of the suction port 15a is on the outer peripheral side of the absorber 201 and is exposed toward the top plate portion 24a of the nozzle guard 24. Therefore, air which is sucked with the suction pump 16 and which flows in via the slit 24c passes from the inner peripheral side of the absorber 201 in a width direction of the absorber 201, and is guided to the outer peripheral side of the absorber 201. Air guided to the outer peripheral side of the absorber 201 runs downward through the outer peripheral side of the absorber 201 or through the groove 32k to reach the suction port 15a, and is then sucked. Therefore, the extent of the negative pressure in the space S on the outer peripheral side of the absorber 201 is higher than that of the space S on the inner peripheral side of the absorber 201.

Here, the excess ink Y which flows out of the nozzle holes 31a and is absorbed in the absorber 201 is pushed out toward the outer peripheral side of the absorber 201 by air which passes through the absorber 201 from the inner peripheral side to the outer peripheral side, and is guided into the groove 32k on the outer peripheral side of the absorber 201 together with the air. The excess ink Y guided into the groove 32k flows downward in the groove 32k to be discharged from the suction port 15a to the waste liquid tank E.

Further, as described above, because the lower end portion 201b covers the upper half portion of the suction port 15a, the excess ink Y contained in the absorber 201 can be positively guided to the suction port 15a. The reason is that, because the suction port 15a is in contact with the absorber 201 via the lower end portion 201b, the suction power easily reaches the absorber 201. More specifically, the upper half portion of the suction port 15a can directly suck out the excess ink Y contained in the absorber 201, while the lower half portion of the suction port 15a can cause the pressure in the space in the groove 32k to be negative and can guide the excess ink Y from the whole periphery of the absorber 201. This enables continuous suction of the excess ink Y absorbed in the absorber 201, which can promptly dry the absorber 201 to suppress saturation of absorption by the absorber 201.

In this way, according to this embodiment, by disposing the absorber 201 so as to cover a part of the discharge hole 32d along the plane and so as to fill the space between the nozzle guard 24 and the nozzle plate 31, the inner peripheral side and the outer peripheral side of the absorber 201 are divided by the absorber 201. Therefore, effects similar to those of the first embodiment described above can be produced.

(Modified Example)

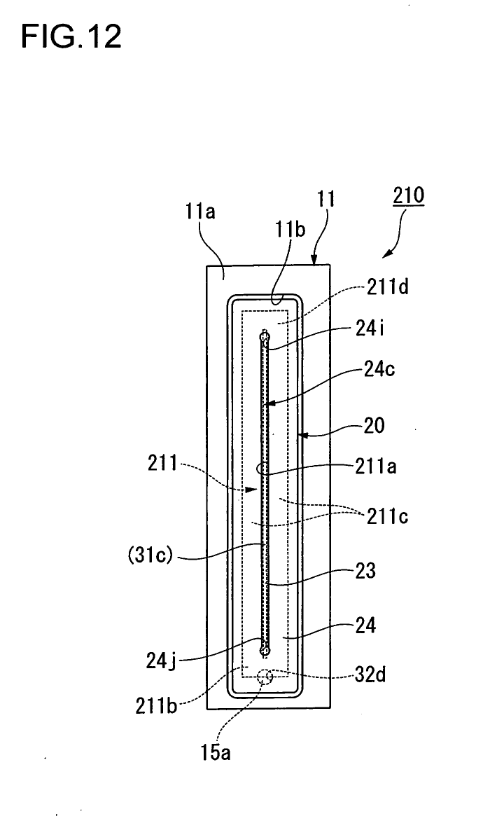

Next, a specific modified example of the ink jet head 200 is described. It is to be noted that like numerals and symbols are used to designate like or identical members in the inkjet head 200, and description thereof is omitted. FIG. 12 is a plan view of an ink jet head illustrating a modified example of the present invention.

As illustrated in FIG. 12, in an ink jet head 210 of this modified example, an absorber 211 is disposed so as to surround the whole periphery of the slit 24c on the plane of the top plate portion 24a of the nozzle guard 24. More specifically, the absorber 211 includes a lower end portion 211b which covers the upper half portion of the suction port 15a seen in plan view, side portions 211c which are on both sides of the nozzle column 31c and which extend in the direction of arrangement of the nozzle column 31c from both ends of the lower end portion 211b in the width direction, and an upper end portion 211d formed so as to run between one ends of the side portions 211c, respectively. Further, the inner peripheries of the side portions 211c of the absorber 211 are disposed so as to be seen through the slit 24c seen in plan view. In other words, the absorber 201 is formed so as to be O-shaped seen in plan view and so as to have a slit 211a the shape of which is substantially the same as that of the slit 24c. The width of the slit 211a in the absorber 211 is formed so as to be smaller than the width of the slit 24c in the nozzle guard 24, which causes the inner periphery of the absorber 211 to extend beyond the inner side of the slit 24c. It is to be noted that the absorber 211 is formed of a material similar to that of the absorber 60 (see FIG. 4) of the first embodiment described above.

Further, the absorber 211 is disposed so as to fill the whole region in the direction of the space between the nozzle guard 24 and the nozzle plate 31. In other words, the thickness of the space S is equal to the thickness of the absorber 211.

According to the structure, because the inner periphery of the absorber 211 is disposed so as to outreach the edges of the slit 24c, the excess ink Y which reaches the vicinity of the slit 24c can be reliably absorbed, and the excess ink Y can be prevented from leaking from the nozzle guard 24.

### Third Embodiment

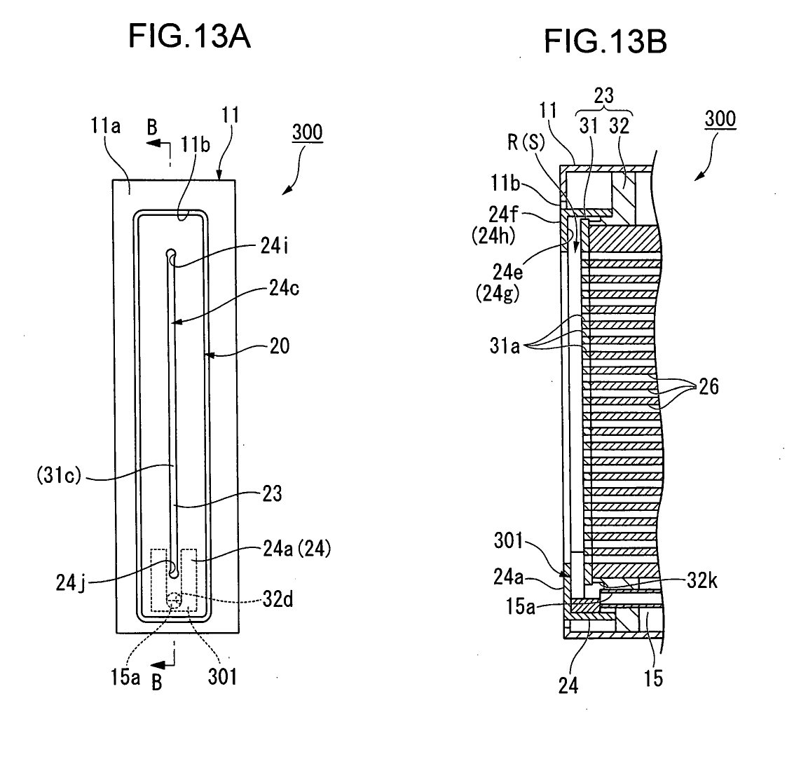

Next, a third embodiment of the present invention is described. It is to be noted that like numerals and symbols are used to designate like or identical members in the first embodiment described above, and description thereof is omitted. FIG. 13 illustrate an ink jet head in the third embodiment of the present invention. FIG. 13(a) is a plan view and FIG. 13(b) is a sectional view taken along the line B-B of FIG. 13(a). This embodiment is different from the first and second embodiments in that an absorber is disposed only in proximity to the discharge hole.

As illustrated in FIG. 13, in an ink jet head 300 of this embodiment, an absorber 301 is disposed in a lower portion of the ink jet head 300 in the direction of gravity. More specifically, the absorber 301 is disposed so as to cover the lower half portion of the suction port 15a seen in plan view and so as to cover both sides of the lower end portion 24j of the slit 24c. Therefore, the upper half portion of the discharge hole 32d is exposed toward the top plate portion 24a of the nozzle guard 24. Therefore, when air in the space S is sucked with the suction pump 16, air directly passes through the upper half portion of the discharge hole 32d without passing through the absorber 301, and air in the space S can be efficiently sucked to cause the space S to be the uniform negative pressure chamber R.

The absorber 301 is disposed so as to fill the whole region in the direction of the space between the nozzle guard 24 and the nozzle plate 31 (horizontal direction in FIG. 13(b)). In other words, the thickness of the space S is equal to the thickness of the absorber 301. Further, the lower end portion of the absorber 301 extends in the direction of the space from the top plate portion 24a of the nozzle guard 24 toward the suction port 15a, and an end surface thereof is in abutting contact with a lower half portion of the suction port 15a.

According to the structure, the excess ink Y which flows out of the nozzle holes 31a and flows downward (downward in the direction of gravity) on the nozzle plate 31 is, in a lower portion of the nozzle plate 31, partly absorbed in the absorber 301, but the rest of the excess ink Y is not absorbed in the absorber 301 and directly reaches the discharge hole 32d to be discharged to the waste liquid tank E. The excess ink Y absorbed in the absorber 301 is sucked with the suction pump 16 and is guided to the waste liquid tank E. Therefore, effects similar to those of the first embodiment described above can be produced.

Further, because the absorber 301 covers the lower half portion of the suction port 15a so as to be in abutting contact therewith as described above, the excess ink Y contained in the absorber 301 can be positively guided to the suction port 15a. The reason is that, because the absorber 301 is in contact with the lower half portion of the suction port 15a, the suction power of the suction pump 16 (see FIG. 2) easily reaches the absorber 301. More specifically, the lower half portion of the suction port 15a can directly suck out the excess ink Y contained in the absorber 301.

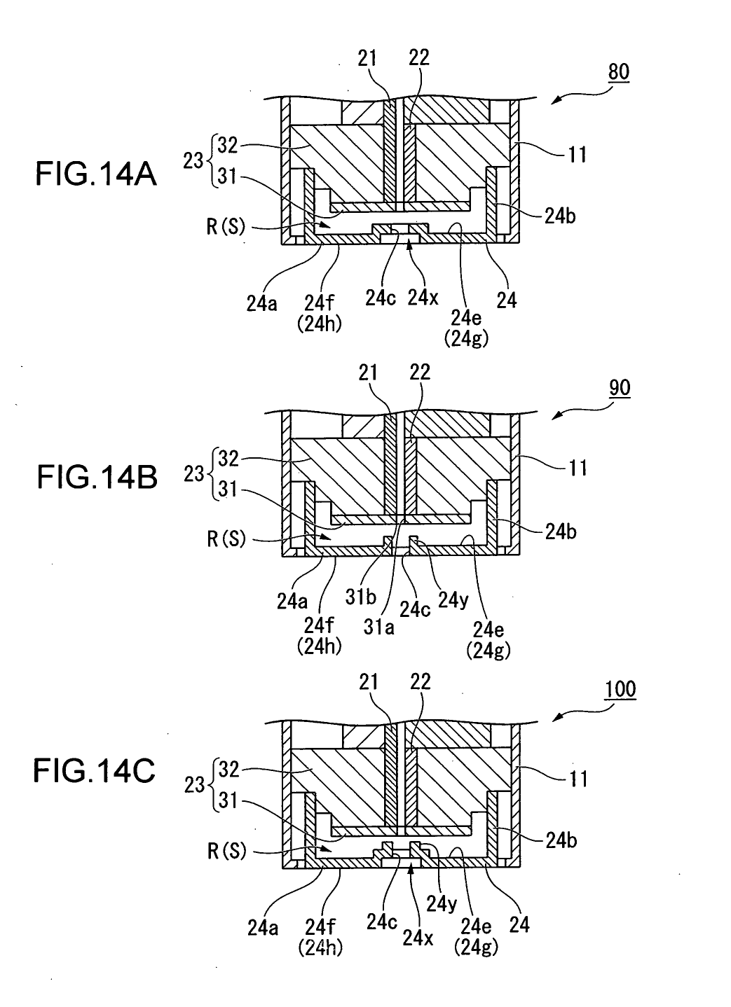

FIG. 14 illustrate modified examples of the ink jet head 10. It is to be noted that, in the respective figures, the absorber is omitted.

FIG. 14(a) illustrates an ink jet head 80 as a modified example of the ink jet head 10. As illustrated in FIG. 14(a), a recessed portion 24x which is recessed toward the negative pressure chamber R side is formed in the top plate portion 24a of the nozzle guard 24 of the ink jet head 80. The recessed portion 24x is formed by press forming (rolling), and the slit 24c is formed in a bottom surface of the recessed portion 24x. With this, even if the box D is brought into contact with the nozzle guard 24, the probability of contact of the water-repellent film 24h in proximity to the slit 24c with the box D is reduced, and the water-repellent film 24h can be prevented from peeling off.

FIG. 14 (b) illustrates an inkjet head 90 as a modified example of the ink jet head 10. As illustrated in FIG. 14(b), a ring-shaped protruding wall 24y which protrudes to the negative pressure chamber R side and which surrounds the slit 24c in the shape of a ring is formed on the nozzle guard 24 of the ink jet head 90. With this, when the ink I is discharged toward the box D with the nozzle orifices 31b of the ink jet head 90 being oriented downward, even if the excess ink Y remains in the space S after the pressure in the negative pressure chamber R recovers, the excess ink Y can be blocked from running on the inner surface 24e to reach the slit 24c and can be prevented from leaking via the slit 24c.

FIG. 14(c) illustrates an ink jet head 100 as a modified example of the ink jet head 10. As illustrated in FIG. 14(c), the recessed portion 24x and the ring-shaped protruding wall 24y are formed by press forming in/on the nozzle guard 24 of the ink jet head 100. With this, the water-repellent film 24h can be prevented from peeling off, and, when the ink I is discharged toward the box D with the nozzle orifices 31b of the ink jet head 100 being oriented downward, the excess ink Y can be prevented from leaking via the slit 24c.

It is to be noted that, by press forming, the recessed portion 24x and the ring-shaped protruding wall 24y can be simultaneously formed, and thus, the production efficiency becomes satisfactory.

It is to be noted that the operation procedure or the shapes and combinations of the structural members described in the above-mentioned embodiments are only exemplary, and various modifications based on design requirements and the like, which fall within the gist of the present invention, are possible.

For example, in the above-mentioned embodiments, the nozzle body 23 is formed of the nozzle plate 31 and the nozzle cap 32 and the ring-shaped end portion of the nozzle guard 24 is attached to the nozzle cap 32 so as to cover the nozzle cap 32, but the ring-shaped end portion of the nozzle guard 24 may be attached to the nozzle plate 31 so as to cover the nozzle plate 31 on condition that the suction port 15a is open to the space S.

Further, in the above-mentioned embodiments, the suction port 15a is formed to fit into the discharge hole 32d formed in the nozzle cap 32, but the discharge hole 32d may be formed in the nozzle plate 31 or the nozzle guard 24, or, the suction flow path 15 may be connected to the discharge hole 32d and the discharge hole 32d may be the suction port.

Further, in the above-mentioned embodiments, the water-repellent film 24h is formed by fluorine resin coating or Teflon (registered trademark) plating, but a water-repellent sheet may be stuck, or a water-repellent agent may be applied.

Further, in the above-mentioned embodiments, the hydrophilic film 24g is formed by titanium coating, but gold plating may be given, or an alkaline agent may be applied.

Further, in the above-mentioned embodiments, the ink jet recording apparatus 1 is formed with the ink jet head 10 being fixed, but it is also possible to form the ink jet recording apparatus 1 with the ink jet head 10 being movable. More specifically, by adopting the ink jet head 10, an ink jet recording apparatus which eliminates the necessity of a cap for suction under negative pressure maybe achieved.

Further, in the above-mentioned embodiments, the arrangement of the nozzle column 31c of the ink jet head 10 is provided in the direction of gravity and the openings of the nozzle holes 31a are provided in the horizontal direction, but the present invention is not limited thereto. The openings of the nozzle holes 31a may be provided in the direction of gravity and the nozzle column 31c may be provided to extend in the horizontal direction.

Further, in the above-mentioned embodiments, the suction pump is operated in the initial filling and in the cleaning, but there is a case in which the ink I droops from the nozzle holes 31a even when printing is carried out, and the ink I in such a case may be collected.

Further, in the first embodiment described above, a structure in which the absorber 60 is disposed on the end surface of the nozzle plate 31 is described, but the present invention is not limited thereto, and the absorber 60 may be disposed on the top plate portion 24a of the nozzle guard 24. Further, a structure in which the discharge hole 32d is not covered with the absorber is also possible. With this, the excess ink Y which overflows from the nozzle holes 31a is reliably absorbed in the absorber before reaching the slit 24c formed in the top plate portion 24a. This can prevent the excess ink Y from leaking to the outside via the slit 24c.

Further, when, for example, the absorber is disposed on either the top plate portion 24a of the nozzle guard 24 or the end surface of the nozzle plate 31, it is preferred that the absorber be disposed so as to cover the suction port 15a seen in plan view. On the other hand, when the absorber is disposed so as to fill the space between the nozzle guard 24 and the nozzle plate 31, it is preferred that the absorber be disposed so as to cover only a part of the suction port 15a seen in plan view and so as not to cover all the suction port 15a.

Further, the embodiments and modified examples described above may be appropriately combined.

Further, a structure is also possible in which the absorber is disposed on both the top plate portion 24a of the nozzle guard 24 and the end surface of the nozzle plate 31, or in which the absorber is disposed in an intermediate region between the nozzle guard 24 and the nozzle plate 31.

Further, in the above, it is described that the slit 24c formed in the top plate portion 24a of the nozzle guard is formed so as to be over a portion in which the nozzle orifices 31b are formed, but it is enough that the plate surface of the top plate portion 24a is formed so as not to be immediately above the nozzle orifices 31b. In other words, it is enough that the top plate portion 24a is formed so as not to cover the nozzle orifices 31b. With this, the top plate portion 24a can be formed to the maximum extent possible to the places in which the nozzle orifices 31b are formed, and thus, the negative pressure state of the negative pressure chamber R can be kept satisfactory.

Further, in the embodiments described above, with regard to the head chip 20, as illustrated in FIGS. 6 and 7, the open hole 22c is open to the whole long grooves 26, but the present invention is not limited thereto. For example, slits which communicate with every other long groove 26 may be formed in the ink chamber plate 22 to form the long grooves 26 into which the ink I is introduced and the long grooves 26 into which the ink I is not introduced. By adopting this form, even if the ink I is conductive, for example, the plate-like electrodes 28 on adjacent side walls 27 do not establish a short circuit and independent ink discharge can be achieved.

More specifically, the head chip described in the above-mentioned embodiments is not specifically limited, and a nonconductive oil-based ink, a conductive water-based ink, a solvent ink, a UV ink, or the like may be used. By structuring the liquid jet head in this way, inks having any properties can be used. In particular, a conductive ink can be used without problems and the added value of the liquid jet recording apparatus can increase. It is to be noted that other actions and effects can be produced similarly.

Further, in the above-mentioned embodiments, as an actuator for discharging the ink I, the ceramic piezoelectric plate 21 having electrodes provided thereon is included, but the present invention is not limited thereto. For example, the mechanism may be provided, in which an electrothermal conversion element is used to generate air bubbles in the chamber into which the ink I is filled and the ink I is discharged by the pressure of the air bubbles.

Further, in the above-mentioned embodiments, as an example of the liquid jet recording apparatus, the ink jet printer 1 is described, but the present invention is not limited to a printer, and, for example, may be applied to a facsimile machine or an on-demand printer.

Further, in the above-mentioned embodiments, as illustrated in FIG. 2, the excess ink Y sucked by the suction pump 16 is discharged to the waste liquid tank E, but the present invention is not limited thereto. For example, a structure connected to the flow path on the outlet side of the suction pump 16 may be not a waste liquid tank but the ink tank 51. More specifically, the excess ink Y sucked by the suction pump 16 may be supplied to the ink tank 51 and the ink may be supplied from the ink tank 51 to the ink jet head 10 as the ink I. By adopting this form, the excess ink Y may be reused as the ink I.

In addition to this structure, in reusing the excess ink Y, a filter member may be provided in the flow path from the suction pump 16 to the ink tank 51. By adopting this structure, impurities contained in the excess ink Y may be removed and ink in an appropriate state may be supplied to the ink tank 51.

Further, in reusing the excess ink Y, a deaerator may be provided in the flow path from the suction pump 16 to the ink tank 51. By adopting this structure, air bubbles contained in the excess ink Y may be removed and ink in an appropriately deaerated state may be supplied to the ink tank 51.

However, the structures described above are not necessarily required to be used and may be appropriately used according to the specifications of a droplet jet recording apparatus.

### Description of Symbols

1 . . . ink jet recording apparatus (liquid jet recording apparatus)
10, 70, 80, 90, 95, 100, 200, 300 . . . ink jet head (liquid jet head)
12 . . . liquid supply system
15 . . . suction flow path
15a . . . suction port
16 . . . suction pump (sucking portion)
21 . . . ceramic piezoelectric plate (actuator)
23 . . . nozzle body (jetting body)
24 . . . nozzle guard (jetting body guard)
24a . . . top plate portion
24b . . . airtight portion
24c . . . slit
24e . . . inner surface
24f . . . outer surface
24g . . . hydrophilic film
24h . . . water-repellent film
26 . . . long groove (pressure generating chamber)
31a . . . nozzle hole
31b . . . nozzle orifice (nozzle)
31c . . . nozzle column (jetting hole column)
32k . . . groove
60, 101, 111, 201, 301 . . . absorber
I . . . ink (first liquid)
R . . . negative pressure chamber
S . . . space (inside space)
W . . . cleaning liquid (second liquid)

1. A liquid jet head including a jetting body having a jetting hole column formed of a plurality of jetting holes, a plurality of pressure generating chambers which are paired with and communicate with the plurality of jetting holes, respectively, a liquid supply system for supplying a first liquid to the plurality of pressure generating chambers, and an actuator disposed adjacent to the plurality of pressure generating chambers, the actuator being driven to pressurize the plurality of pressure generating chambers, thereby causing the first liquid in the plurality of pressure generating chambers to be jetted from liquid nozzles of the plurality of jetting holes,
the liquid jet head comprising:
a jetting body guard formed so as to cover the jetting body, the jetting body guard comprising a top plate portion, the top plate portion being disposed away from a surface of the jetting body and having a slit formed therein so as to be opposed to the jetting hole column, and an airtight portion for hermetically sealing space between a peripheral portion of the top plate portion and the jetting body; and
an absorber for absorbing the first liquid which overflows from the plurality of jetting holes, the absorber being disposed between the top plate portion of the jetting body guard and the jetting body.

2. A liquid jet head according to claim 1, further comprising a suction flow path which has, on one end side thereof, a suction port which is open below the jetting hole column of the jetting body while another end side thereof being connected to a sucking portion to communicate with inside space of the jetting body guard in a case where the jetting hole column is disposed in a vertical direction,
wherein the inside space of the jetting body guard is caused to be a negative pressure chamber by suction with the sucking portion via the suction flow path, thereby sucking the first liquid which overflows from the plurality of jetting holes into the negative pressure chamber.

3.-20. (canceled)

21. A method of filling liquid into a liquid jet head, the liquid jet head including a nozzle body having a nozzle column formed of a plurality of nozzle holes, a plurality of pressure generating chambers which are paired with and communicate with the plurality of nozzle holes, respectively, a liquid supply system for supplying a first liquid to the plurality of pressure generating chambers, and an actuator disposed adjacent to the plurality of pressure generating chambers, the actuator being driven to pressurize the plurality of pressure generating chambers, thereby causing the first liquid in the plurality of pressure generating chambers to be jetted from nozzles of the plurality of nozzle holes,
the liquid jet head further including:
a nozzle guard formed so as to cover the nozzle column, the nozzle guard including a top plate portion, the top plate portion being disposed away from a surface of the nozzle body and having a slit formed therein so as to be opposed to the nozzle column, and an airtight portion for hermetically sealing space between a peripheral portion of the top plate portion and the nozzle body; and
a suction flow path which has a suction port that is open below the nozzle column and which communicates with inside space of the nozzle guard,
the inside space of the nozzle guard being caused to be a negative pressure chamber by a sucking portion connected to the suction flow path, the first liquid which overflows from the plurality of nozzle holes into the negative pressure chamber being sucked,
the method comprising pressurized filling the first liquid into the plurality of pressure generating chambers, the pressurized filling being carried out using the liquid supply system, under a state in which pressure in the negative pressure chamber is caused to be lower than atmospheric pressure by the sucking portion.

22. A method of filling liquid into a liquid jet head according to claim 21, wherein the pressurized filling ends under the state in which the pressure in the negative pressure chamber is caused to be lower than the atmospheric pressure by the sucking portion.

23.-24. (canceled)
